(19) United States
(12) Patent Application Publication
(10) Pub. No.: US 2025/0028629 A1
(43) Pub. Date: Jan. 23, 2025

(54) AUTOMATED QUERY LANGUAGE PERFORMANCE METRICS

(71) Applicant: VMware LLC, Palo Alto, CA (US)

(72) Inventors: ASHISH AGRAWAL, Pune (IN); Amit Meena, Pune (IN); Geeta Gokhale, Pune (IN); Siddharth Burle, Pune (IN)

(21) Appl. No.: 18/377,774

(22) Filed: Oct. 7, 2023

(30) Foreign Application Priority Data
Jul. 20, 2023 (IN) 202341048935

(51) Int. Cl. G06F 11/36

(52) U.S. Cl. CPC G06F 11/3688; G06F 11/3684

(57) ABSTRACT

Systems, apparatus, articles of manufacture, and methods are disclosed to test an automated query language by interfacing with a query endpoint, generating a first test suite based on a plurality of combinations of a plurality of attributes corresponding to an API specification, transmitting the first test suite to be executed on the query endpoint, the first test suite to include instructions to cause the query endpoint to access data stored in a database accessible to a plurality of secondary endpoints, obtaining a response time corresponding to the access of the data, comparing the response time corresponding to the access of the data with a service level agreement required response time, and in response to the response time corresponding to the access of the data being longer than the service level agreement required response time, notifying a developer of the plurality of secondary endpoints.

### RELATED APPLICATIONS

Benefit is claimed under 35 U.S.C. 119 (a)-(d) to Foreign application No. 202341048935 filed in India entitled “AUTOMATED QUERY LANGUAGE PERFORMANCE METRICS”, on Jul. 20, 2023, by VMware, Inc., which is herein incorporated in its entirety by reference for all purposes.

### FIELD OF THE DISCLOSURE

This disclosure relates generally to cloud provisioning resources and, more particularly, to automated query language performance metrics.

### BACKGROUND

In recent years, query languages have been developed to request and/or retrieve data from databases by a transmission of queries. In some examples, a query language is a database query language. In some examples, a query language is an information retrieval query language. GraphQL® was developed by FACEBOOK® as a data query language and runtime for executing those queries against application programming interfaces (API).

### BRIEF DESCRIPTION OF THE DRAWINGS

FIG. 1 is a schematic block diagram of an example environment in which an example microservice deployment device operates to manage deployment of microservices of a distributed computing system.

FIG. 2 is a block diagram of an example of a query language endpoint retrieving data across multiple different databases of deployed microservices.

FIG. 3 is a block diagram of an example environment in which performance framework circuitry operates to determine the performance of the query language endpoint.

FIG. 4 is a block diagram of an example implementation of the test suite generation circuitry of FIG. 3.

FIG. 5 is a block diagram of an example implementation of the analyzer circuitry of FIG. 3.

FIG. 6 is an example sequence diagram describing the operation of the performance framework circuitry.

FIG. 7 is an example pipeline diagram describing the integration of the performance framework circuitry in a build promotion decision for the deployment of the microservices.

FIG. 8 is a flowchart representative of example machine readable instructions and/or example operations that may be executed, instantiated, and/or performed by example programmable circuitry to implement test suite generation circuitry of FIGS. 3 and 4.

FIG. 9 is a flowchart representative of example machine readable instructions and/or example operations that may be executed, instantiated, and/or performed by example programmable circuitry to implement the analyzer circuitry of FIGS. 3 and 5.

FIG. 10 is a representative of example results generated by the test suite execution circuitry of FIG. 3 of the performance framework circuitry of FIG. 3 and analyzed by the example analyzer circuitry of FIGS. 3 and 5 of the performance framework circuitry of FIG. 3.

FIG. 11 is a database representation of an application programming interface (API) specification that is introspected upon by the example test suite generation circuitry of FIGS. 3 and 4 of the performance framework circuitry of FIG. 3.

FIG. 12 is a database representation of an API service level agreement (SLA) that is used by the example test suite generation circuitry of FIGS. 3 and 4 of the performance framework circuitry of FIG. 3.

FIG. 13 is a database representation of an endpoint specification that is used by the example test suite generation circuitry of FIGS. 3 and 4 of the performance framework circuitry of FIG. 3.

FIG. 14 is a block diagram of an example processing platform including programmable circuitry structured to execute, instantiate, and/or perform the example machine readable instructions and/or perform the example operations of FIGS. 8 and 9 to implement the performance framework circuitry 330 of FIG. 3.

FIG. 15 is a block diagram of an example implementation of the programmable circuitry of FIG. 14.

FIG. 16 is a block diagram of another example implementation of the programmable circuitry of FIG. 14.

FIG. 17 is a block diagram of an example software/firmware/instructions distribution platform (e.g., one or more servers) to distribute software, instructions, and/or firmware (e.g., corresponding to the example machine readable instructions of FIGS. 8 and 9) to client devices associated with end users and/or consumers (e.g., for license, sale, and/or use), retailers (e.g., for sale, re-sale, license, and/or sub-license), and/or original equipment manufacturers (OEMs) (e.g., for inclusion in products to be distributed to, for example, retailers and/or to other end users such as direct buy customers).

In general, the same reference numbers will be used throughout the drawing(s) and accompanying written description to refer to the same or like parts. The figures are not necessarily to scale.

Unless specifically stated otherwise, descriptors such as “first,” “second,” “third,” etc., are used herein without imputing or otherwise indicating any meaning of priority, physical order, arrangement in a list, and/or ordering in any way, but are merely used as labels and/or arbitrary names to distinguish elements for ease of understanding the disclosed examples. In some examples, the descriptor “first” may be used to refer to an element in the detailed description, while the same element may be referred to in a claim with a different descriptor such as “second” or “third.” In such instances, it should be understood that such descriptors are used merely for identifying those elements distinctly within the context of the discussion (e.g., within a claim) in which the elements might, for example, otherwise share a same name.

As used herein, “approximately” and “about” modify their subjects/values to recognize the potential presence of variations that occur in real world applications. For example, “approximately” and “about” may modify dimensions that may not be exact due to manufacturing tolerances and/or other real world imperfections as will be understood by persons of ordinary skill in the art. For example, “approximately” and “about” may indicate such dimensions may be within a tolerance range of +/−10% unless otherwise specified in the below description.

As used herein “substantially real time” refers to occurrence in a near instantaneous manner recognizing there may be real world delays for computing time, transmission, etc. Thus, unless otherwise specified, “substantially real time” refers to real time+1 second.

As used herein, the phrase “in communication,” including variations thereof, encompasses direct communication and/or indirect communication through one or more intermediary components, and does not require direct physical (e.g., wired) communication and/or constant communication, but rather additionally includes selective communication at periodic intervals, scheduled intervals, aperiodic intervals, and/or one-time events.

As used herein, “programmable circuitry” is defined to include (i) one or more special purpose electrical circuits (e.g., an application specific circuit (ASIC)) structured to perform specific operation(s) and including one or more semiconductor-based logic devices (e.g., electrical hardware implemented by one or more transistors), and/or (ii) one or more general purpose semiconductor-based electrical circuits programmable with instructions to perform specific functions(s) and/or operation(s) and including one or more semiconductor-based logic devices (e.g., electrical hardware implemented by one or more transistors). Examples of programmable circuitry include programmable microprocessors such as Central Processor Units (CPUs) that may execute first instructions to perform one or more operations and/or functions, Field Programmable Gate Arrays (FPGAs) that may be programmed with second instructions to cause configuration and/or structuring of the FPGAs to instantiate one or more operations and/or functions corresponding to the first instructions, Graphics Processor Units (GPUs) that may execute first instructions to perform one or more operations and/or functions, Digital Signal Processors (DSPs) that may execute first instructions to perform one or more operations and/or functions, XPUs, Network Processing Units (NPUs) one or more microcontrollers that may execute first instructions to perform one or more operations and/or functions and/or integrated circuits such as Application Specific Integrated Circuits (ASICs). For example, an XPU may be implemented by a heterogeneous computing system including multiple types of programmable circuitry (e.g., one or more FPGAs, one or more CPUs, one or more GPUs, one or more NPUs, one or more DSPs, etc., and/or any combination(s) thereof), and orchestration technology (e.g., application programming interface(s) (API(s)) that may assign computing task(s) to whichever one(s) of the multiple types of programmable circuitry is/are suited and available to perform the computing task(s).

As used herein, integrated circuit/circuitry is defined as one or more semiconductor packages containing one or more circuit elements such as transistors, capacitors, inductors, resistors, current paths, diodes, etc. For example an integrated circuit may be implemented as one or more of an ASIC, an FPGA, a chip, a microchip, programmable circuitry, a semiconductor substrate coupling multiple circuit elements, a system on chip (SoC), etc.

### DETAILED DESCRIPTION

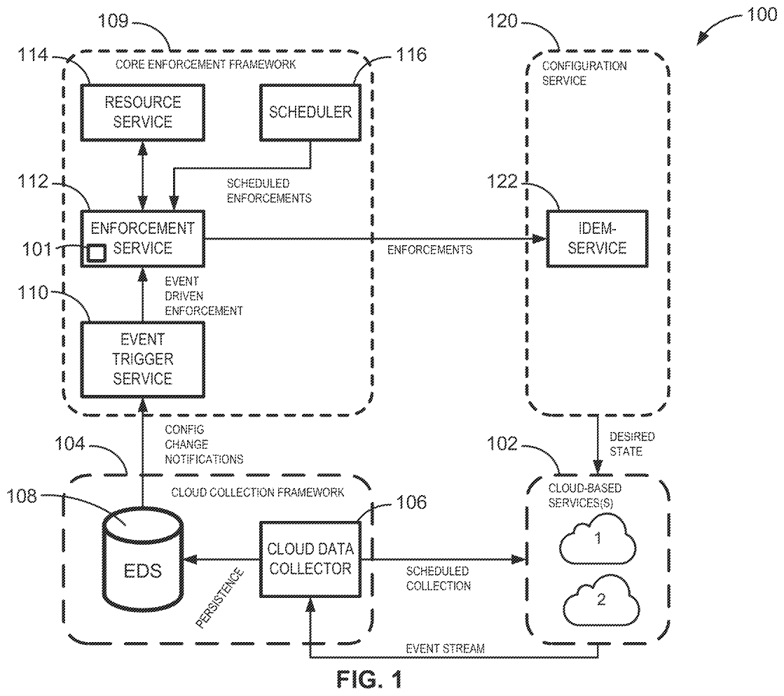

FIG. 1 is a schematic block diagram of an example environment 100 in which an example microservice deployment device 101 operates to manage deployment of microservices of a distributed computing system. In the illustrated example of FIG. 1, aspects and/or components of the environment 100 function as a system that manages operations and usage of at least one cloud-based service 102. The management of the operations can pertain to configuring settings, managing resource usage and/or managing access of the cloud-based service(s) 102. The example architecture shown in the example of FIG. 1 is only an example and any other architecture, network, control scheme, communication and/or data topology can be implemented instead.

According to examples disclosed herein, an example cloud collection framework 104 includes an example cloud data collector 106 to coordinate and communicate with the cloud-based service(s) 102. To that end, the example cloud data collector 106 extracts, receives and/or queries information (e.g., components, metadata, services, service information) from the cloud-based service(s) 102. In this example, the cloud data collector 106 requests and/or directs the cloud-based service(s) 102 to provide information related to: (1) accounts utilizing the cloud-based service(s) 102, (2) at least one configuration of the cloud-based service(s) 102 and/or (3) services of the cloud-based service(s) 102. The request by the cloud data collector 106 to the cloud-based service(s) 102 can be driven by an occurrence of an event or performed on periodic or aperiodic timeframes and/or on a schedule. According to examples disclosed herein, the cloud-based service(s) 102 provide(s) data, requested changes, configuration information and/or updates associated with the cloud-based service(s) 102 to the cloud data collector 106 in response to a query from the cloud data collector 106 or without receiving a query from the cloud data collector 106. In some examples, the aforementioned data and/or updates provided to the cloud data collector 106 can include changes of a configuration of the cloud-based service(s) 102 and/or operational data of the cloud-based service(s) 102.

In this example, the aforementioned cloud collection framework 104 also includes an example entity data service (EDS) 108. The example EDS 108 can be implemented as a database, data store, database manager and/or database framework to store and/or collect data associated with the cloud-based service(s) 102. The example EDS 108 stores entity data of the cloud-based service(s) 102 in a normalized form (e.g., as a centralized repository). According to examples disclosed herein, the EDS 108 can provide any requested or proposed configuration change request to a core enforcement framework 109 which, in turn, includes an example event trigger service 110, an example enforcement service 112 that implements the aforementioned microservice deployment device 101, an example resource service 114 and an example scheduler 116. For example, when an event occurs, such as a rule change and/or a configuration change corresponding to the cloud-based service(s) 102, a notification from the EDS 108 is provided to the event trigger service 110.

The event trigger service 110 of the illustrated example is implemented to direct enforcement, configuration changes and/or access to services (e.g., microservices) of the cloud-based service(s) 102. The example event trigger service 110 can map a configuration change event to a desired state of the cloud service(s). Accordingly, the example event trigger service 110 can direct control, usage and/or configuration of the cloud-based service(s) 102 via (or in conjunction with) the aforementioned enforcement service 112. In this example, the event trigger service 110 provides requests and/or commands pertaining to event-driven enforcement of the cloud-based service(s) 102 to the enforcement service 112. In some examples, the event trigger service 110 manages and/or directs changes to key value data stores. In some examples, the event trigger service 110 can utilize and/or implement a Kubernetes cluster.

The example enforcement service 112 determines, manages and provides enforcements (e.g., configuration changes, access changes, resource usage instructions, a desired state change, etc.) with respect to the cloud-based service(s) 102 to a configuration service 120 based on the event-driven enforcements and/or instructions received from the event trigger service 110. Additionally or alternatively, notifications (e.g., configuration change notifications), enforcements and/or instructions received from the resource service 114 and the scheduler 116 cause the enforcement service 112 to provide enforcements to the configuration service 120. In turn, the enforcements provided to the configuration service 120 are subsequently provided to the cloud-based service(s) 102 as desired state changes (e.g., desired state change instructions or directives).

In this example, the resource service 114 stores and/or manages operational data and/or settings of the cloud-based service(s) 102. In this example, the resource service 114 contains, analyzes and/or manages metadata of the cloud-based service(s) 102 that is utilized to manage the cloud-based service(s) 102. In particular, the metadata corresponds to settings, access information and/or configurations of the cloud-based service(s) 102, for example.

In some examples, the aforementioned scheduler 116 directs and/or manages scheduled implementations, configuration changes, enforcements and/or updates (e.g., periodic updates) of the cloud-based service(s) 102 via the example enforcement service 112 and the configuration service 120. For example, the scheduler 116 can schedule the enforcement service 112 to perform scheduled enforcements of the configuration service 120 which, in turn, controls and/or directs a desired state of the cloud-based service(s) 102.

To control, manage, enforce and/or direct operation of the cloud-based service(s) 102, as mentioned above, the example enforcement service 112 provides the enforcements to the configuration service 120. In this example, the configuration service 120 includes an idempotent (IDEM) service 122 that is distinct from the core enforcement framework 109 and, thus, the enforcement service 112. However, the IDEM service 122 can be integrated with the enforcement service 112 and/or the core enforcement framework 109 in other examples. In the illustrated example of FIG. 1, the IDEM service 122 is an implementation/provisioning engine that implements desired state changes with respect to the cloud-based service(s) 102. In other words, the IDEM service 122 controls a desired state of the cloud-based service(s) 102 based on enforcements provided from the enforcement service 112. While the microservice deployment device 101 is shown implemented in the example event trigger service 110, additionally or alternatively, the microservice deployment device 101 can be implemented in the enforcement service 112, the resource service 114 and/or the scheduler 116.

As mentioned above, any appropriate data topology, architecture and/or structure can be implemented instead. Further, any of the aforementioned aspects and/or elements described in connection with FIG. 1 can be combined or separated as appropriate. Further, while examples disclosed herein are shown in the context of cloud services, examples disclosed herein can be implemented in conjunction with any appropriate distributed and/or shared computing resource system.

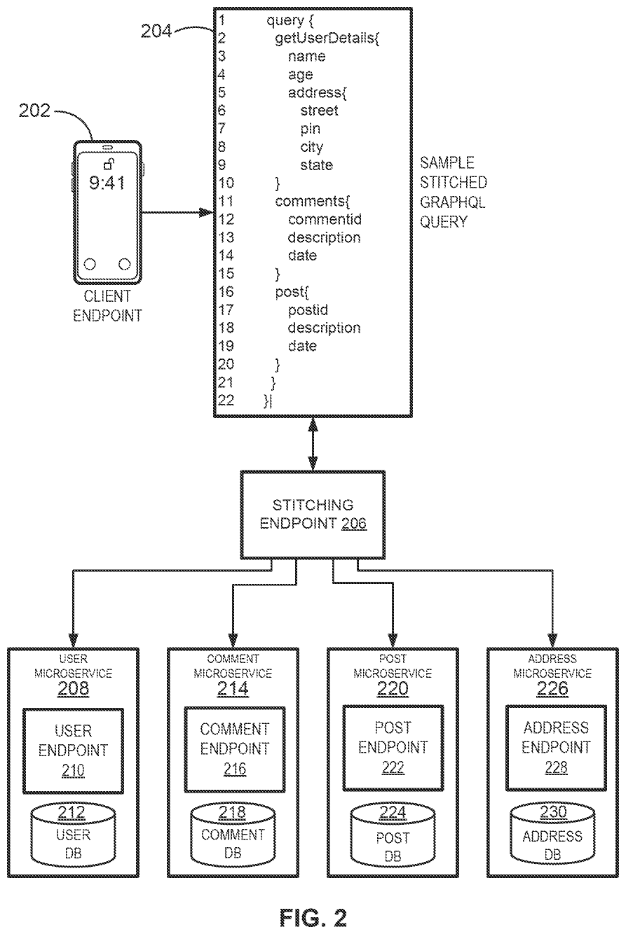

FIG. 2 is a block diagram of an example of a query language endpoint retrieving data across multiple different databases of deployed microservices. FIG. 2 illustrates an example client endpoint 202, an example stitched query 204, an example stitching endpoint 206 (e.g., query language endpoint, GraphQL endpoint, automated query language endpoint, etc.), an example user microservice 208, an example user endpoint 210, an example user database 212, an example comment microservice 214, an example comment endpoint 216, an example comment database 218, an example post microservice 220, an example post endpoint 222, an example post database 224, an example address microservice 226, an example address endpoint 228, and an example address database 230.

The example of FIG. 2 illustrates retrieval across multiple ones of the example databases 212, 218, 224, and 230 for a GraphQL system. However, in other examples, other query languages other than GraphQL may be used. Throughout the specification, GraphQL is referred to by example, but any other type of query language may be utilized at each instance of a reference to GraphQL. A query language is a computer programming language that is to request, retrieve, access, modify data which is stored in databases. The query language is to access the data by sending (e.g., transmitting) a query.

The GraphQL language is an alternative to the REpresentational State Transfer (REST) language. For example, a client using REST makes a request and in the REST language, multiple endpoints return fixed data structures. Those data structures may include the requested data, but, also, include additional data that was not requested. In contrast, a client using GraphQL, can request, with the stitching endpoint 206, the particular data required without requesting (e.g., receiving, retrieving) the entirety of the data structure, which may include un-requested (e.g., un-desired) data from each of the single endpoints. In other words, GraphQL, by only returning data that is requested, reduces both the amount of over-fetching of data and the amount of under-fetching of data. By reducing the over-fetching of un-requested data and reducing the under-fetching of requested data, GraphQL leads to a more efficient and flexible application programming interface (API).

The GraphQL architecture uses stitching (e.g., joining of databases, retrieving data across databases, etc.) to provide a unified interface. As shown in FIG. 2, a user (not shown) uses the example client endpoint 202 (e.g., mobile phone, laptop, etc.) to request a stitched query 204. The user may not be aware that retrieving (e.g., fetching, requesting) of a particular set of data (e.g., the name, age, street address, city, state, comment identifier, comment description, comment date, message post identifier, message post description and message post date) will cause accesses of multiple databases (e.g., at least the example databases 212, 218, 224, and 230) to collect all of the different data elements.

For example, requesting name data and age data in the example stitching query 204 will cause the stitching endpoint 206 (e.g., the GraphQL endpoint, the query language endpoint) to communicate with the user endpoint 210 which has access to the user database 212. The example user database 212 includes the data corresponding to the name of the user and the data corresponding to the age of the user.

For example, requesting the street address, the city, and the state in the stitching query 204 will cause the example stitching endpoint 206 to communicate with the address endpoint 228, where the address endpoint 228 has access to the address database 230.

Similarly, the comment identifier, comment description and comment data correspond to data stored in the comment database 218 that is directly accessible by the comment endpoint 216 and is indirectly accessible to the stitching endpoint 206 through communication with the comment endpoint 216.

Similarly, the post date, the post identifier, and the post description are stored in the post database 224 and the post endpoint 222 will transmit this data to the stitching endpoint 206 in response to a request from the stitching endpoint 206.

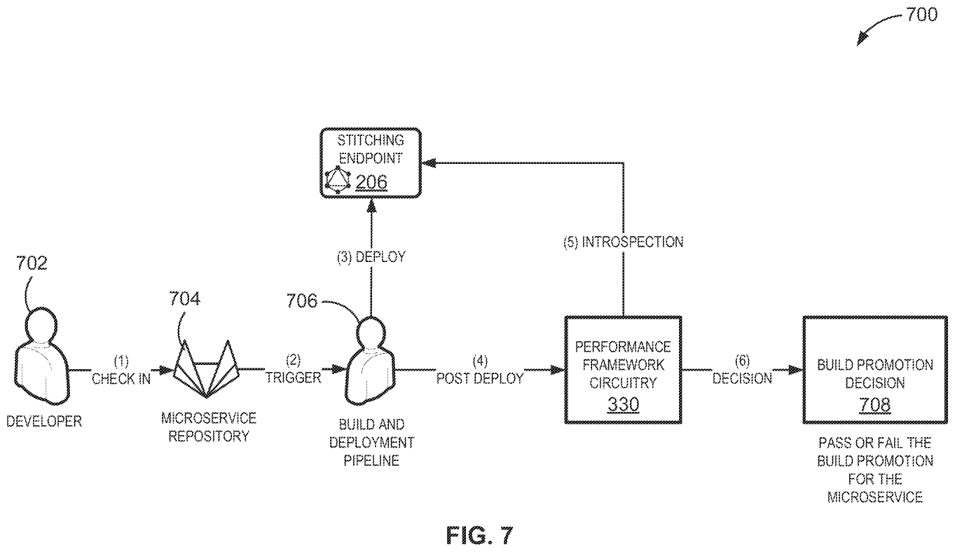

Different developers (e.g., teams, tenants, programmers, etc.) may manage the different databases 212, 218, 224, and 230. In other examples, the different databases 212, 218, 224, and 230 are hosted on different servers and the individual endpoints (e.g., the user endpoint 210, the comment endpoint 216, the post endpoint 222, and the address endpoint 228) are unified and exposed as a single endpoint (e.g., the stitching endpoint 206). In some examples, the developers manage different microservices such as the microservices listed in the microservice repository 704 of FIG. 7.

One of the benefits of using the GraphQL language (or any similar query protocol) is that stitching allows for creation of complex application programming interfaces (APIs) that integrate multiple data sources. However, one of the issues with using the GraphQL language is that, because the data is fetched from different sources and unified as a single endpoint (e.g., the stitching endpoint 206), there are latencies inherited from the different microservices (e.g., the user microservice 208, the comment microservice 214, the post microservice 220, and the address microservice 226) that are indistinguishable. For example, a developer may be unable to determine which microservice is a primary cause of the latency. In some examples, the different ones of the example microservices 208, 214, 220, and 226 with the different databases 212, 218, 224, and 230 and the different individual endpoints 210, 216, 222, and 228 are referred to as sub-systems.

Different sub-systems of a query environment may have different latencies. In some examples, due to the different latencies between the different sub-systems, there is a first difficulty to determine the average latencies across subgraphs. For example, the subgraphs (e.g., different microservices) are graphs which have vertices and edges that are subsets of another graph (e.g., the application). In such examples, there is an increased difficulty (compared to the first difficulty) to predictably validate and verify that the specific endpoint of the individual endpoints 210, 216, 222, and 228 is conforming to a targeted latency (e.g., set forth in an SLA). Due to these two difficulties, there is an unpredictable user interface (UI) performance which directly impacts the user (e.g., client, customer) and degrades the overall usability of the application.

For example, deriving performance metrics for the example stitching endpoint 206 is difficult because of the distributed nature of an architecture that uses the GraphQL language, complex data patterns, data variability, and a lack of standard metrics. For example, stitching involves combining different microservices (e.g., APIs) which may be distributed across different servers or even different geographic locations. Therefore, there is a difficulty in measuring the overall performance of the example stitching endpoint 206 as the performance of the example stitching endpoint 206 depends on the performance of the individual services (APIs). Furthermore, stitching allows for complex query patterns that span multiple services (e.g., APIs). The complex query patterns increase the difficulty of tracking the performance of individual queries. The complex query patterns increase the difficulty in understanding how the queries are being executed across the various services (e.g., APIs). The data that is stitched may originate from different sources. The stitched data may have different characteristics such as different data types, different data sizes, and/or different data complexities. Therefore, there is a challenge to optimize performance and predict the behavior of the example stitching endpoint 206.

Moreover, the lack of a standard set of performance metrics for the individual endpoints (e.g., the user endpoint 210, the comment endpoint 216, the post endpoint 222, and the address endpoint 228) introduces a challenge to compare the performance of the different endpoints and determine what performance levels are considered acceptable.

In a system that uses GraphQL, the example stitching endpoint 206 combines multiple GraphQL APIs into a single, unified schema. Therefore, when multiple microservices teams are contributing and collaborating for supporting the single unified schema, there is a difficulty for the multiple microservices teams to adhere to a performance SLA. In such examples, the size and complexity of the individual APIs that the example stitching endpoint 206 is combining is correlated to the response times. Identifying the impact of each of the attributes on the overall performance of the unified schema is a difficult combinatorial problem. With a large number of attributes, there is a difficulty to predictably validate and confirm the SLA specification for the individual endpoint of the plurality of endpoints 210, 216, 222, 228. The microservice team, after developing or updating the microservice has to confirm, validate, affirm the SLA per node and the SLA per attribute. Typically, the microservice team has to revalidate the microservice which is both error-prone and resource intensive. In some examples, there is a difficulty in testing the functional aspect of the microservice without deploying the updated microservice (which may not reach the target SLAs).

One of the issues with GraphQL is that the different microservices have different SLAs. If a stitching request requests data from only a first database, the latency may achieve the SLA. If a second stitching request requests data from a second database, the latency may also achieve the SLA. However, if a third stitching request requests data from both the first database and the second database, the latencies associated with receiving the combined data may be greater than the allowed latency that is set forth in the SLA. While retrieving data from either of the databases independently, did not violate the SLAs, by retrieving data from both the databases, there was a violation of the SLA.

For example, retrieving the name of a user, which is stored in the user database 212, and retrieving a post date, which is stored in the post database 224, may not violate the SLA in terms of a combined latency. However, in this example, retrieving the name of a user, which is stored in the user database 212, and retrieving a post description, which is stored in the post database 224, may violate the SLA in terms of a combined latency, because the post date (e.g., May 1, 2023) may be a different data type than the post description. These different SLAs for the different microservices are dependent on the specific attributes (e.g., street, pin, city, and state). The techniques disclosed herein test the different attributes with different test suites to determine if a certain combination of requested attributes violates the latency described in the SLA. Thus, there is an emphasis on performance testing of the GraphQL APIs that can be extended to cater to the functional, duration, and longevity testing.

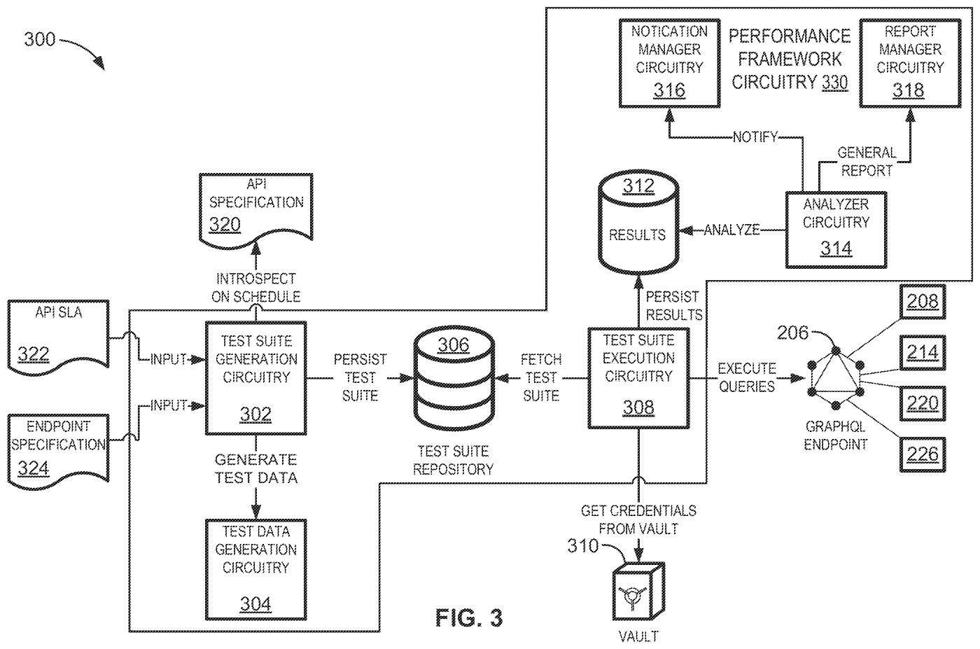

FIG. 3 is a block diagram of an example environment 300 in which example performance framework circuitry 330 operates. The example performance framework circuitry 330 includes example test suite generation circuitry 302, example test suite execution circuitry 308, and example analyzer circuitry 314. The example performance framework circuitry 330 may be implemented in the microservice deployment device 101.

The example environment 300 of FIG. 3 includes the example stitching endpoint 206, the example user microservice 208, the example comment microservice 214, the example post microservice 220, the example address microservice 226, the example test suite generation circuitry 302, example test data generation circuitry 304, an example test suite repository 306, example test suite execution circuitry 308, an example vault 310, an example results database 312, example analyzer circuitry 314, example notification manager circuitry 316, example report manager circuitry 318, an example API specification 320, an example API SLA 322, and an example endpoint specification 324.

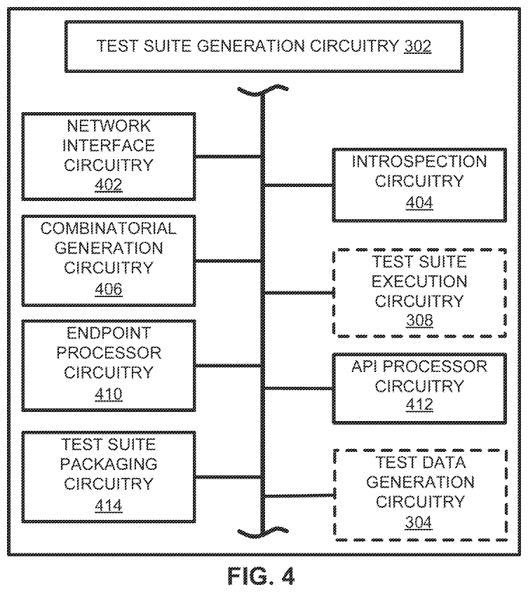

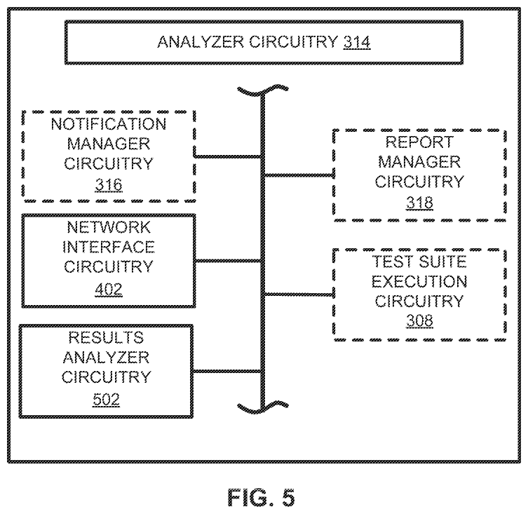

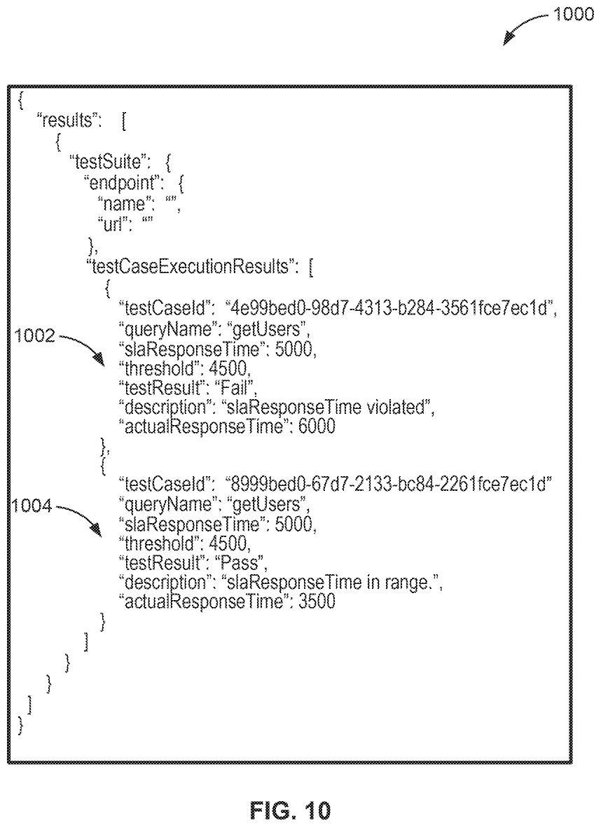

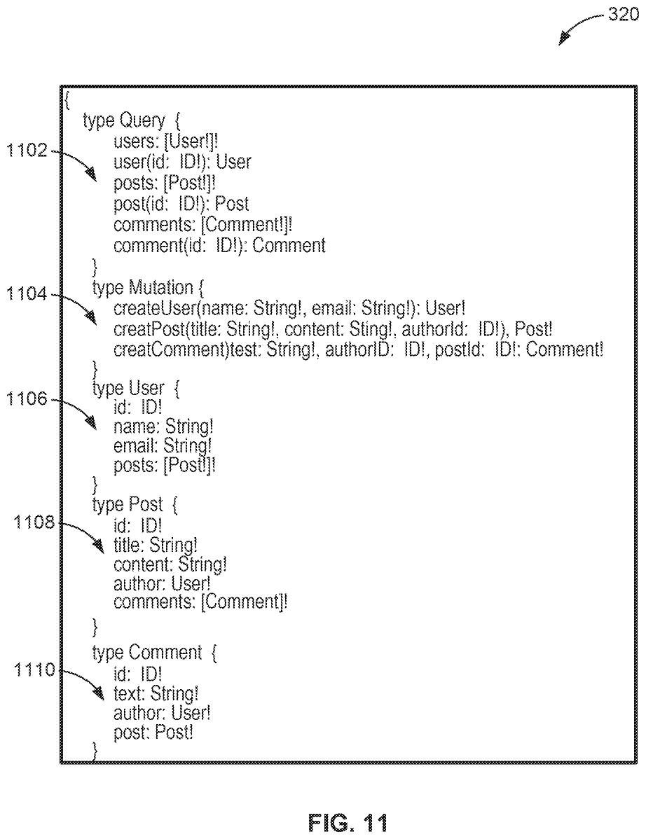

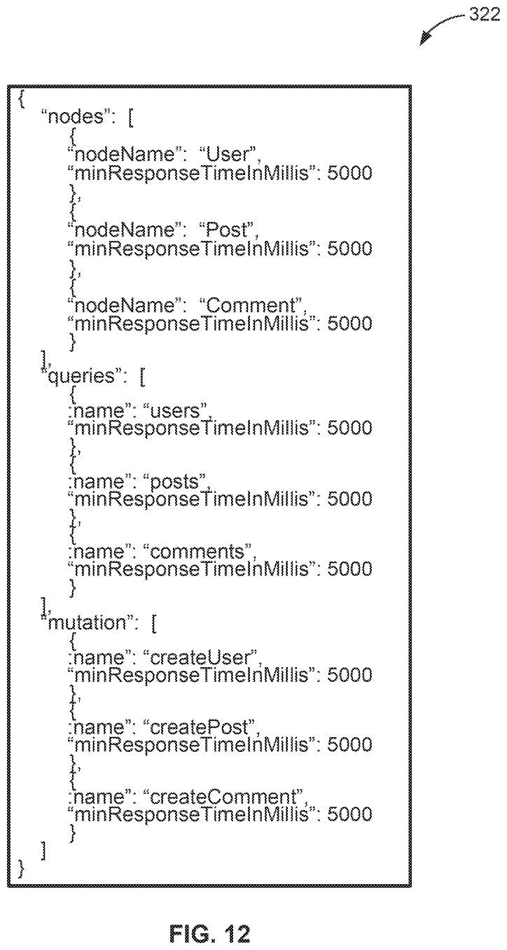

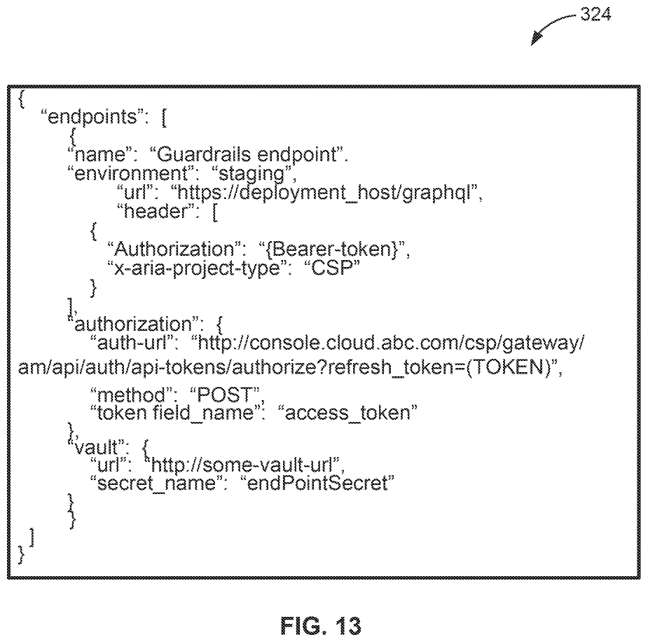

FIG. 4 describes an example implementation of the test suite generation circuitry 302. FIG. 5 describes an example implementation of the analyzer circuitry 314. FIG. 10 describes results that may be stored in the results database 312. FIG. 11 illustrates a database representation (e.g., JSON representation) of the example API specification 320. FIG. 12 illustrates a database representation (e.g., JSON representation) of the example API SLA 322. FIG. 13 illustrates a database representation (e.g., JSON representation) of the example endpoint specification 324.

The example performance framework circuitry 330 is one logical grouping of the various components of FIG. 3. However, in other examples, other groupings of the various components of FIG. 3. For example, one set of groupings is to group the test suite generation circuitry 302 and the test data generation circuitry 304, and to group the analyzer circuitry 314 with the example notification manager circuitry 316 and the example report manager circuitry 318. In this set of groupings, the test suite execution circuitry 308 retrieves test suites from the example test suite repository 306 and persists the results in the example results database 312 to be accessed by the group of the analyzer circuitry 314, the notification manager circuitry 316, and the report manager circuitry 318. In some examples, the components are not grouped and are stand-alone instances of circuitry which communicate via a network with one another.

FIG. 3 is a block diagram of an example implementation of the performance framework circuitry 330 to determine performance of an automated query language endpoint by generating test suites, executing the generated test suites, and analyzing the results corresponding to the executed test suites. The performance framework circuitry 330 of FIG. 3 may be instantiated (e.g., creating an instance of, bring into being for any length of time, materialize, implement, etc.) by programmable circuitry such as a Central Processor Unit (CPU) executing first instructions. Additionally or alternatively, the performance framework circuitry 330 of FIG. 3 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 3 may, thus, be instantiated at the same or different times. Some or all of the circuitry of FIG. 3 may be instantiated, for example, in one or more threads executing concurrently on hardware and/or in series on hardware. Moreover, in some examples, some or all of the circuitry of FIG. 3 may be implemented by microprocessor circuitry executing instructions and/or FPGA circuitry performing operations to implement one or more virtual machines and/or containers.

The example test suite generation circuitry 302 is to generate test suites. The test suites are used by the test suite execution circuitry 308 to determine whether latencies are achieved or violated when different attributes are requested. The test suite generation circuitry 302 begins generation of the test suites in response to an indication that at least one microservice has been updated and deployed. The example test suite generation circuitry 302 receives the example API SLA 322 as a first input and the example endpoint specification 324 as a second input. The example test suite generation circuitry 302 introspects on the example API specification 320 where the API specification 320 is a representation of a live version of the deployment which includes the updated microservice (e.g., the user microservice 208, the comment microservice 214, the post microservice 220, the example address microservice 226). The example test suite generation circuitry 302 is to introspect on the example API specification by determining the available queries and mutations that are available to access, retrieve, modify, and request data.

Then, based on the introspection of the example API specification 320, the example test suite generation circuitry 302 uses the example test data generation circuitry 304 to generate test data. The test suite generation circuitry 302 then packages the test data, the SLAs that correspond to the example API SLA 322, and the example endpoint specification 324 as a first test suite. The example test suite generation circuitry 302 persists the example first test suite in the example test suite repository 306. In some examples, the test suite generation circuitry 302 transmits the first test suite to the example test suite execution circuitry 308. In some examples, the test suite generation circuitry 302 generates a second test suite in response to a subsequent notification that another one of the microservices has been updated.

The example test suite execution circuitry 308 retrieves (e.g., fetches) the first test suite from the example test suite repository 306. In some examples, the test suite execution circuitry 308 retrieves the first test suite from the example test suite generation circuitry 302. The example test suite execution circuitry 308 uses the data corresponding to the endpoint specification 324 to determine the uniform resource locator (URL) address for the example stitching endpoint 206 (e.g., GraphQL endpoint, query language endpoint). The example test suite execution circuitry 308 uses the data corresponding to the example endpoint specification 324 to access the credentials from the example vault 310. For example, the first test suite includes data corresponding to the endpoint specification 324. The example endpoint specification 324, as described in connection with FIG. 13, includes an authorization token which allows access to the example vault 310. The example test suite execution circuitry 308 uses the authorization token to retrieve the credentials to use the example stitching endpoint 206.

The example test suite execution circuitry 308 executes the first test suite with the example stitching endpoint 206. The first test suite may include queries (e.g., retrieval of data from the databases 212, 218, 224, 230 of the microservices 208, 214, 220, 226) and mutations (e.g., editing the data from the databases 212, 218, 224, 230 of the microservices 208, 214, 220, 226). The first test suite may include a first test case which includes two queries for the user database 212 and an example mutation for the comment database 218. The first test suite may include a second test case which includes two mutations for the user database 212, an example query for the comment database 218 and an example query for the example address database 230. The first test suite includes multiple combinations of queries and mutations for the different microservices.

The example test suite execution circuitry 308 records the actual response times for the microservices to completing the individual combinations of queries and mutations. The example test suite execution circuitry 308 persists the actual response times and the data corresponding to the API SLA 322 from the first test suite in the example results database 312. In some examples, the test suite execution circuitry 308 transmits the actual response times and the data corresponding to the API SLA 322 from the first test suite to the example analyzer circuitry 314.

The example analyzer circuitry 314 analyzes the results by comparing the actual response times to the target SLAs. The target SLAs include a warning threshold response time which triggers a warning to the developers of the microservices and a SLA required response time (e.g., failure response time) which triggers a failure notification to the developers and prevents the microservice from being updated. Turning briefly to FIG. 10, the first test case 1002 has an SLA required response time of five thousand milliseconds and a warning threshold response time of four thousand and five hundred milliseconds. The example test case 1002, with an actual response time of six thousand milliseconds, violated both the warning threshold response time and the SLA required response time. The example test case 1004, with an actual response time of three thousand and five hundred milliseconds, did not violate the warning threshold response time of four thousand and five hundred milliseconds, nor the SLA required response time of five thousand milliseconds.

Returning to FIG. 3, the analyzer circuitry 314 compares the target SLAs with the actual response times to determine if the target SLAs were achieved or violated. The analyzer circuitry 314 then transmits the indication of achieving the SLA or violating the SLA to the example notification manager circuitry 316 and the example report manager circuitry 318. The example notification manager circuitry 316 notifies the build pipeline (e.g., deployment pipeline) with an indication to either pass the build promotion for the integration of the updated microservice to the deployment or to fail the build promotion for the integration of the updated microservice and continue using the previous microservice in the build promotion. The example report manager circuitry 318 generates a report that lists the target SLA required response time, the warning threshold response time, and the actual response time, and the queries or mutations used in the test cases. The example report manager circuitry 318 transmits the report to the developers of the updated microservice.

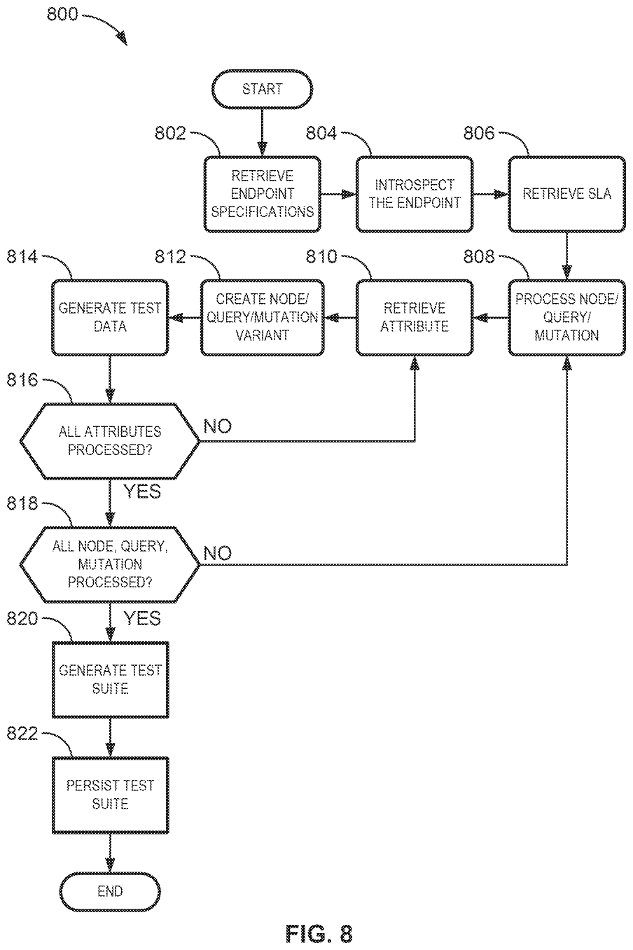

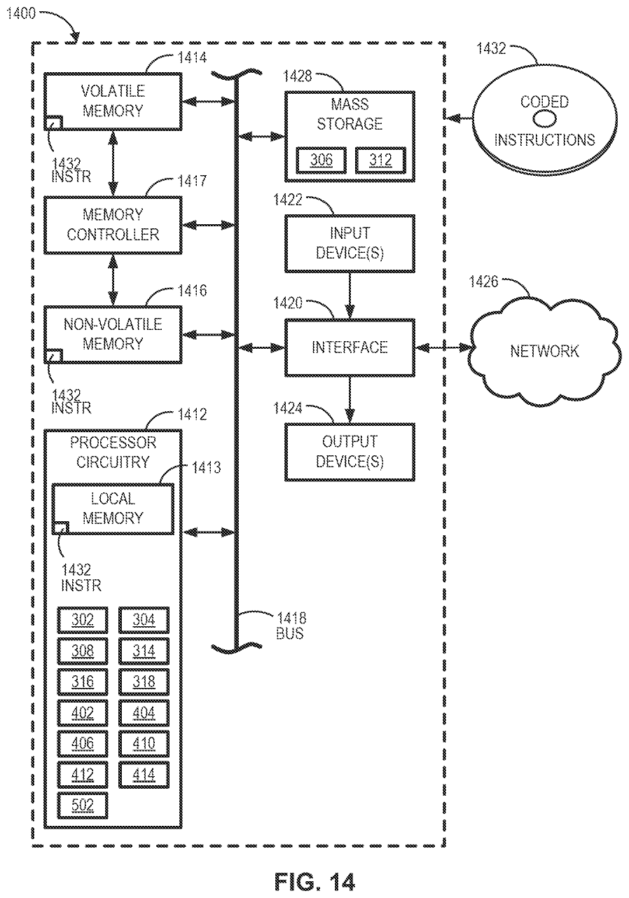

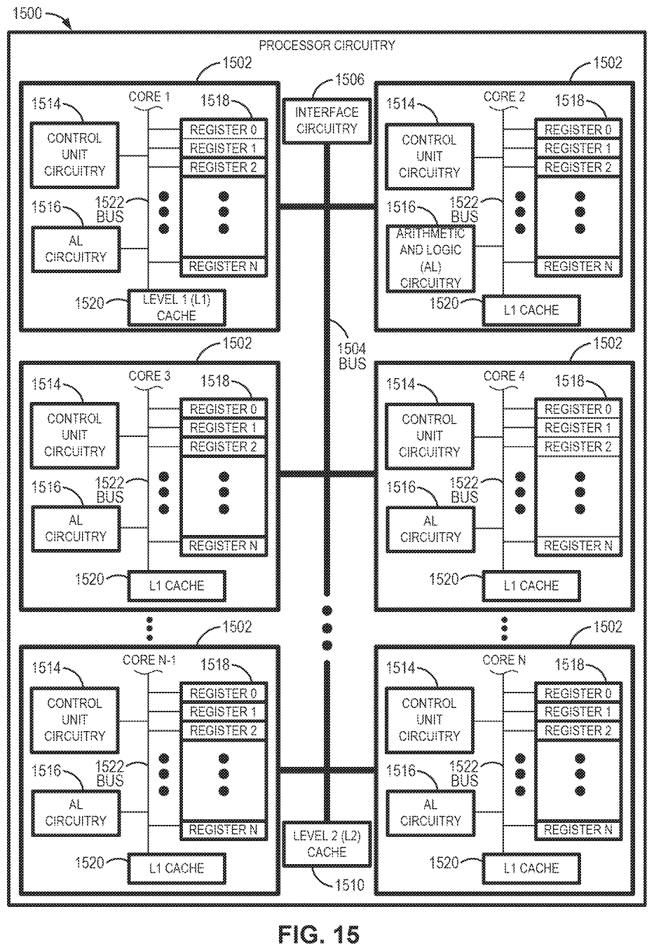

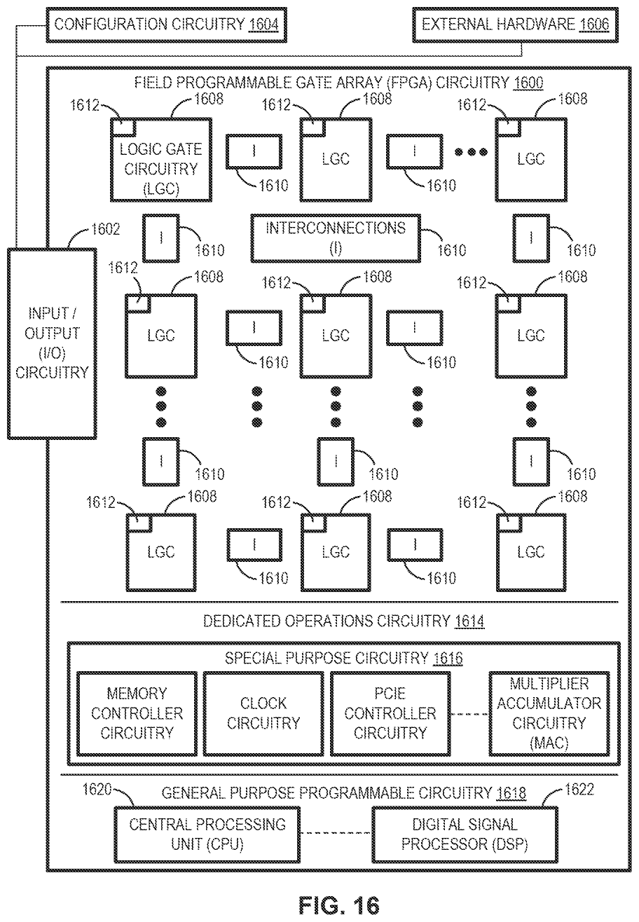

In some examples, the performance framework circuitry 330 includes means for generating a test suite. For example, the means for generating a test suite may be implemented by test suite generation circuitry 302. In some examples, the test suite generation circuitry 302 may be instantiated by programmable circuitry such as the example programmable circuitry 1412 of FIG. 14. For instance, the test suite generation circuitry 302 may be instantiated by the example microprocessor 1500 of FIG. 15 executing machine executable instructions such as those implemented by at least blocks 802, 804, 806, 808, 810, 812, 814, 816, 818, 820, and 822 of FIG. 8. In some examples, test suite generation circuitry 302 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the test suite generation circuitry 302 may be instantiated by any other combination of hardware, software, and/or firmware. For example, the test suite generation circuitry 302 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

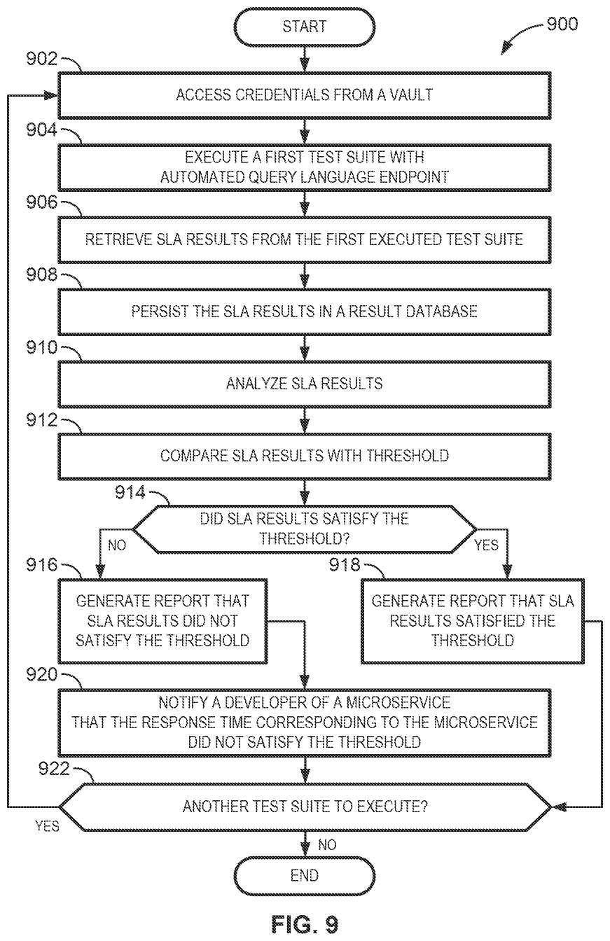

In some examples, the performance framework circuitry 330 includes means for executing a test suite. For example, the means for executing a test suite may be implemented by test suite execution circuitry 308. In some examples, the test suite execution circuitry 308 may be instantiated by programmable circuitry such as the example programmable circuitry 1412 of FIG. 14. For instance, the test suite execution circuitry 308 may be instantiated by the example microprocessor 1500 of FIG. 15 executing machine executable instructions such as those implemented by at least blocks 902, 904, 906, 908, and 922 of FIG. 9. In some examples, test suite execution circuitry 308 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the test suite execution circuitry 308 may be instantiated by any other combination of hardware, software, and/or firmware. For example, the test suite execution circuitry 308 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

In some examples, the performance framework circuitry 330 includes means for analyzing test suite results. For example, the means for analyzing may be implemented by analyzer circuitry 314. In some examples, the analyzer circuitry 314 may be instantiated by programmable circuitry such as the example programmable circuitry 1412 of FIG. 14. For instance, the analyzer circuitry 314 may be instantiated by the example microprocessor 1500 of FIG. 15 executing machine executable instructions such as those implemented by at least blocks 910, 912, 914, 916, and 918 of FIG. 9. In some examples, analyzer circuitry 314 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the analyzer circuitry 314 may be instantiated by any other combination of hardware, software, and/or firmware. For example, the analyzer circuitry 314 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 4 is a block diagram of an example implementation of the test suite generation circuitry 302 of FIG. 3 to generate test suites. The test suite generation circuitry 302 of FIG. 4 may be instantiated (e.g., creating an instance of, bring into being for any length of time, materialize, implement, etc.) by programmable circuitry such as a Central Processor Unit (CPU) executing first instructions. Additionally or alternatively, the test suite generation circuitry 302 of FIG. 4 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 4 may, thus, be instantiated at the same or different times. Some or all of the circuitry of FIG. 4 may be instantiated, for example, in one or more threads executing concurrently on hardware and/or in series on hardware. Moreover, in some examples, some or all of the circuitry of FIG. 4 may be implemented by microprocessor circuitry executing instructions and/or FPGA circuitry performing operations to implement one or more virtual machines and/or containers.

FIG. 4 includes example network interface circuitry 402, example introspection circuitry 404, example combinatorial generation circuitry 406, example endpoint processor circuitry 410, example API processor circuitry 412, and example test suite packaging circuitry 414. In some examples, the test suite generation circuitry 302 of FIG. 4 includes the test suite execution circuitry 308 and the test data generation circuitry 304 as shown by the dashed lines.

The example network interface circuitry 402 is to communicate with the developers of the microservices. In some examples, the network interface circuitry 402 of the test suite generation circuitry 302 is to communicate with network interface circuitry 402 instantiated in the test suite execution circuitry 308. The example network interface circuitry 402 is to receive the example API SLA 322 (FIG. 3) and the example endpoint specification 324 (FIG. 3).

In some examples, the network interface circuitry 402 is instantiated by programmable circuitry executing network interface instructions and/or configured to perform operations such as those represented by the flowchart(s) of FIGS. 8-9.

In some examples, the network interface circuitry 402 includes means for communicating data. For example, the means for communicating may be implemented by network interface circuitry 402. In some examples, the network interface circuitry 402 may be instantiated by programmable circuitry such as the example programmable circuitry 1412 of FIG. 14. For instance, the network interface circuitry 402 may be instantiated by the example microprocessor 1500 of FIG. 15 executing machine executable instructions such as those implemented by at least blocks 802, 806, 822 of FIG. 8. In some examples, the network interface circuitry 402 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the network interface circuitry 402 may be instantiated by any other combination of hardware, software, and/or firmware. For example, the network interface circuitry 402 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example introspection circuitry 404 is to perform introspection on the example API specification 320 (FIG. 3). For example, introspection is a process that determines the features available for the deployed API. For example, rather than accessing a document which describes the available features, the introspection circuitry 404 determines those features by sending a particular query which requests a list of the features from the live deployed API. For example, the API specification 320 (FIG. 3) may have a query labeled “get name” and a mutation labeled “edit name.” By introspecting, the introspection circuitry 404 receives an indication that the example API specification 320 (FIG. 3) includes the get name query and the edit name mutation. In some examples, the introspection circuitry 404 sends a query to the API specification 320 for a list of available functions (e.g., queries or mutations). The example introspection circuitry 404 then determines if the get name query has any queries or mutations. For example, there may be a first sub-query which is labeled “get first name” and a second sub-query labeled “get last name.” By introspecting, the example introspection circuitry 404 determines the organization of the data in the database. For example, by determining that there are two sub-queries, the introspection circuitry 404 determines that the name data is stored in two different databases and combined by the get name query. Based on the organization of the data, the example test suite generation circuitry 302 uses the test data generation circuitry 304 to generate sample data that corresponds to the organization of the data.

In some examples, the introspection circuitry 404 is instantiated by programmable circuitry executing introspection instructions and/or configured to perform operations such as those represented by the flowchart(s) of FIGS. 8-9.

In some examples, the introspection circuitry 404 includes means for introspecting an API Specification. For example, the means for introspection may be implemented by introspection circuitry 404. In some examples, the introspection circuitry 404 may be instantiated by programmable circuitry such as the example programmable circuitry 1412 of FIG. 14. For instance, the introspection circuitry 404 may be instantiated by the example microprocessor 1500 of FIG. 15 executing machine executable instructions such as those implemented by at least block 804 of FIG. 8. In some examples, the introspection circuitry 404 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the introspection circuitry 404 may be instantiated by any other combination of hardware, software, and/or firmware. For example, the introspection circuitry 404 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The test data generation circuitry 304 is to generate sample data which follows the organization determined by the introspection of the API specification 320 (FIG. 3). The example test data generation circuitry 304 uses random text generation, random universally unique identifier (UUID) generation, random email address generation, and random number generation. The example test data generation circuitry 304 generates database objects (e.g., JSON objects) for complex data input based on models. For example, the test data generation circuitry 304 may generate a first user with a first name of John and a last name of Smith based on the organization of the data based on the first sub-query (e.g., get first name) and the second sub-query (e.g., get last name). The example test data generation circuitry 304 may generate sample posts or comments that this sample user John Smith may write based on other queries or mutations determined through the introspection (e.g., edit post mutation, amend comment mutation, etc.).

In some examples, the test data generation circuitry 304 is instantiated by programmable circuitry executing test data generation instructions and/or configured to perform operations such as those represented by the flowchart(s) of FIGS. 8-9.

In some examples, the test suite generation circuitry 302 includes means for generating test data. For example, the means for generating may be implemented by test data generation circuitry 304. In some examples, the test data generation circuitry 304 may be instantiated by programmable circuitry such as the example programmable circuitry 1412 of FIG. 14. For instance, the test data generation circuitry 304 may be instantiated by the example microprocessor 1500 of FIG. 15 executing machine executable instructions such as those implemented by at least block 814 of FIG. 8. In some examples, test data generation circuitry 304 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the test data generation circuitry 304 may be instantiated by any other combination of hardware, software, and/or firmware. For example, the test data generation circuitry 304 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example combinatorial generation circuitry 406 is to generate the test cases using the different attributes available for the APIs. For example, the available queries and the available mutations discovered through the introspection circuitry 404 are different attributes. The example introspection circuitry 404 determines the direct attributes (e.g., the get name query) and the complex attributes (e.g., the get first name sub-query and the get last name sub-query). The example combinatorial generation circuitry 406 is to, based on the number of attributes for the different APIs available (e.g., presented) by the stitching endpoint 206 (FIG. 3) generate different test cases. For example, if there are N attributes, then there are N factorial permutations of dynamic test case set for each different API. For example, if the example introspection circuitry 404 determines that there are ten attributes, the combinatorial generation circuitry may generate three million, six hundred twenty-eight thousand, and eight hundred test cases test cases (e.g., 10! test cases is 3,628,800). In some examples, the combinatorial generation circuitry 406 is to, based on the number of attributes for all of the different APIs available, generate the different test cases. In other examples, the combinatorial generation circuitry 406, is to, based on the number of attributes for some of the different APIs available, generate the different test cases.

For example, the combinatorial generation circuitry 406 is to generate a first test case that uses a first query on a first database, and a second test case that uses a second query on a second database, and a third test case that uses the first query on the first database and the second query on the second database and a fourth query that uses the second query on the second database before using the first query on the first database and so on, until all the attributes are used. The test suite generation circuitry 302 uses the combinatorial generation circuitry 406 to generate the individual test cases. Once all the attributes (e.g., the queries and mutations across the APIs, nodes and databases presented by the stitching endpoint 206 (FIG. 2)) are processed into different individual test cases, the test suite generation circuitry 302 uses the test suite packaging circuitry 414 to generate the first test suite. The example test suite generation circuitry 302 generates the test suite to be executed by the test suite execution circuitry 308 based on the different permutations and combinations of different attributes to be requested.

The different attributes are used in the generation of the test suite because, in some examples, requesting first data from a first microservice does not violate the SLA, and requesting second data from a second microservice does not violate the SLA, but requesting both the first data and the second data from the first microservice and the second microservice respectively, violates the SLA. By determining that the SLA is violated, the example performance framework circuitry 330 (FIG. 3) is to approve or deny different deployments of updated microservices and inform the developer of the microservice. This prevents a customer (e.g., user) of the microservice to experience frustration and complain to the developer of the microservice because of slow response times that violate the SLA required response time.

In some examples, the test data generation circuitry 304 is instantiated by programmable circuitry executing test data generation instructions and/or configured to perform operations such as those represented by the flowchart(s) of FIGS. 8-9.

In some examples, the test suite generation circuitry 302 includes means for processing attributes. For example, the means for processing may be implemented by combinatorial generation circuitry 406. In some examples, the combinatorial generation circuitry 406 may be instantiated by programmable circuitry such as the example programmable circuitry 1412 of FIG. 14. For instance, the combinatorial generation circuitry 406 may be instantiated by the example microprocessor 1500 of FIG. 15 executing machine executable instructions such as those implemented by at least blocks 808, 810, 812, 816, 818 of FIG. 8. In some examples, combinatorial generation circuitry 406 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the combinatorial generation circuitry 406 may be instantiated by any other combination of hardware, software, and/or firmware. For example, the combinatorial generation circuitry 406 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example endpoint processor circuitry 410 is to process the example endpoint specification 324 (FIG. 3) in generating the first test suite. For example, the stitching endpoint 206 (FIG. 2) is accessible by a uniform resource locator (URL). The example endpoint processor circuitry 410 is to determine information of the example stitching endpoint 206 (FIG. 2) and convert the information corresponding to the example stitching endpoint 206 (FIG. 3) into information that the example test suite execution circuitry 308 (FIG. 3) uses to access the example stitching endpoint 206 (FIG. 2). The example endpoint processor circuitry 410 is to determine how to invoke endpoints, determine the headers that are to be passed, determine the authorization token generation, and determine an example API request payload. FIG. 13 illustrates an example endpoint specification 324 that the example endpoint processor circuitry 410 is to process.

In some examples, the endpoint processor circuitry 410 is instantiated by programmable circuitry executing endpoint processor instructions and/or configured to perform operations such as those represented by the flowchart(s) of FIGS. 8-9.

In some examples, the test suite generation circuitry 302 includes means for processing endpoints. For example, the means for processing may be implemented by endpoint processor circuitry 410. In some examples, the endpoint processor circuitry 410 may be instantiated by programmable circuitry such as the example programmable circuitry 1412 of FIG. 14. For instance, the endpoint processor circuitry 410 may be instantiated by the example microprocessor 1500 of FIG. 15 executing machine executable instructions such as those implemented by at least block 802 of FIG. 8. In some examples, endpoint processor circuitry 410 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the endpoint processor circuitry 410 may be instantiated by any other combination of hardware, software, and/or firmware. For example, the endpoint processor circuitry 410 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example API processor circuitry 412 is to determine the SLAs from the example API SLA 322 (FIG. 3). Turning briefly to FIG. 12, FIG. 12 illustrates the example SLA required response times that correspond to the different nodes (e.g., databases of the microservices), different queries, and different mutations. In the example of FIG. 12, the example “create user” mutation has an SLA required response time of five thousand milliseconds. Returning to FIG. 4, the example API processor circuitry 412 is to convert the SLA required response times listed in the example API SLA 322 (FIG. 3) into information placed in the example first test suite. The example API processor circuitry 412 also determines warning SLA response times which are placed in the example first test suite. For example, the API processor circuitry 412 may subtract some time from the SLA response time to determine a warning threshold time, which if violated, would trigger a warning notification to the developer of the microservice. For example, the API processor circuitry 412 may determine that the “create user” mutation has an SLA response time of five thousand milliseconds and a warning threshold time of four thousand milliseconds. These SLA required response times and warning threshold times are used by the example analyzer circuitry 314 to determine if the response time recorded from executing the test suite violates the SLA or violates the SLA warning time.

In some examples, the API processor circuitry 412 is instantiated by programmable circuitry executing API processor instructions and/or configured to perform operations such as those represented by the flowchart(s) of FIGS. 8-9.

In some examples, the test suite generation circuitry 302 includes means for processing API SLAs. For example, the means for processing may be implemented by API processor circuitry 412. In some examples, the API processor circuitry 412 may be instantiated by programmable circuitry such as the example programmable circuitry 1412 of FIG. 14. For instance, the API processor circuitry 412 may be instantiated by the example microprocessor 1500 of FIG. 15 executing machine executable instructions such as those implemented by at least block 806 of FIG. 8. In some examples, API processor circuitry 412 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the API processor circuitry 412 may be instantiated by any other combination of hardware, software, and/or firmware. For example, the API processor circuitry 412 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example test suite packaging circuitry 414 is to combine the API SLA required response times, the warning threshold times, the endpoint information, the individual test cases, and the test data into a first test suite. The first test suite is in a format readable by the example test suite execution circuitry 308. The example test suite packaging circuitry 414 persists (e.g., stores) the first test suite in the example test suite repository 306 (FIG. 3). In some examples, the network interface circuitry 402 persists the first test suite in the example test suite repository 306 (FIG. 3).

In some examples, the test suite packaging circuitry 414 is instantiated by programmable circuitry executing test suite packaging instructions and/or configured to perform operations such as those represented by the flowchart(s) of FIGS. 8-9.

In some examples, the test suite generation circuitry 302 includes means for packaging test suites. For example, the means for packaging may be implemented by test suite packaging circuitry 414. In some examples, the test suite packaging circuitry 414 may be instantiated by programmable circuitry such as the example programmable circuitry 1412 of FIG. 14. For instance, the test suite packaging circuitry 414 may be instantiated by the example microprocessor 1500 of FIG. 15 executing machine executable instructions such as those implemented by at least blocks 820, 822 of FIG. 8. In some examples, test suite packaging circuitry 414 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the test suite packaging circuitry 414 may be instantiated by any other combination of hardware, software, and/or firmware. For example, the test suite packaging circuitry 414 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

FIG. 5 is a block diagram of an example implementation of the analyzer circuitry 314 of FIG. 3 to analyze results from the execution of the test suites. The analyzer circuitry 314 of FIG. 5 may be instantiated (e.g., creating an instance of, bring into being for any length of time, materialize, implement, etc.) by programmable circuitry such as a Central Processor Unit (CPU) executing first instructions. Additionally or alternatively, the analyzer circuitry 314 of FIG. 5 may be instantiated (e.g., creating an instance of, bring into being for any length of time, materialize, implement, etc.) by (i) an Application Specific Integrated Circuit (ASIC) and/or (ii) a Field Programmable Gate Array (FPGA) structured and/or configured in response to execution of second instructions to perform operations corresponding to the first instructions. It should be understood that some or all of the circuitry of FIG. 5 may, thus, be instantiated at the same or different times. Some or all of the circuitry of FIG. 5 may be instantiated, for example, in one or more threads executing concurrently on hardware and/or in series on hardware. Moreover, in some examples, some or all of the circuitry of FIG. 5 may be implemented by microprocessor circuitry executing instructions and/or FPGA circuitry performing operations to implement one or more virtual machines and/or containers.

FIG. 5 includes example network interface circuitry 402 and example results analyzer circuitry 502. In some examples, the analyzer circuitry 314 of FIG. 5 includes example test suite execution circuitry 308, example notification manager circuitry 316, and example report manager circuitry 318 as shown by the dashed lines.

The example network interface circuitry 402 is to communicate with the developers of the microservices. In some examples, the network interface circuitry 402 of the analyzer circuitry 314 is to communicate with network interface circuitry 402 instantiated in the test suite execution circuitry 308 to retrieve the results of the execution of the test suites. In some examples, the network interface circuitry 402 accesses the results that are persisted in the example results database 312 (FIG. 3).

The example results analyzer circuitry 502 is to compare the time corresponding to the access (e.g., queries) or modification (e.g., mutations) of the data in the unified API endpoint that is composed of multiple microservices with the SLA required response times and the warning threshold times. For example, if the SLA results (e.g., actual response times) did not achieve the SLA required response times, the results analyzer circuitry 502 determines that the current deployment of the microservices violated the SLA. In the example of FIG. 5, the analyzer circuitry 314 then uses the example notification manager circuitry 316 and the example report manager circuitry 318 to notify the developers.

In some examples, the results analyzer circuitry 502 is instantiated by programmable circuitry executing results analysis instructions and/or configured to perform operations such as those represented by the flowchart(s) of FIGS. 8-9.

In some examples, the analyzer circuitry 314 includes means for analyzing response times. For example, the means for analyzing may be implemented by results analyzer circuitry 502. In some examples, the results analyzer circuitry 502 may be instantiated by programmable circuitry such as the example programmable circuitry 1412 of FIG. 14. For instance, the results analyzer circuitry 502 may be instantiated by the example microprocessor 1500 of FIG. 15 executing machine executable instructions such as those implemented by at least blocks 910, 912, and 914 of FIG. 9. In some examples, results analyzer circuitry 502 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the results analyzer circuitry 502 may be instantiated by any other combination of hardware, software, and/or firmware. For example, the results analyzer circuitry 502 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example notification manager circuitry 316 notifies the build pipeline (e.g., deployment pipeline) with an indication to either pass the build promotion for the integration of the updated microservice to the deployment or to fail the build promotion for the integration of the updated microservice and continue using the previous microservice in the build promotion.

In some examples, the notification manager circuitry 316 is instantiated by programmable circuitry executing results analysis instructions and/or configured to perform operations such as those represented by the flowchart(s) of FIGS. 8-9.

In some examples, the analyzer circuitry 314 includes means for notifying developers. For example, the means for notifying may be implemented by notification manager circuitry 316. In some examples, the notification manager circuitry 316 may be instantiated by programmable circuitry such as the example programmable circuitry 1412 of FIG. 14. For instance, the notification manager circuitry 316 may be instantiated by the example microprocessor 1500 of FIG. 15 executing machine executable instructions such as those implemented by at least block 920 of FIG. 9. In some examples, notification manager circuitry 316 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the notification manager circuitry 316 may be instantiated by any other combination of hardware, software, and/or firmware. For example, the notification manager circuitry 316 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

The example report manager circuitry 318 generates a report that lists the target SLA required response time, the warning threshold response time, and the actual response time, and the queries or mutations used in the test cases. The example report manager circuitry 318 transmits the report to the developers of the updated microservice. In some examples, based on if the actual response times achieved the SLA required response times, the example report manager circuitry 318 does not transmit the successful report to the developers. In some examples, the report manager circuitry 318 transmits the successful report to the developers of the microservice.

In some examples, the notification manager circuitry 316 is instantiated by programmable circuitry executing results analysis instructions and/or configured to perform operations such as those represented by the flowchart(s) of FIGS. 8-9.

In some examples, the analyzer circuitry 314 includes means for generating reports. For example, the means for generating may be implemented by report manager circuitry 318. In some examples, the report manager circuitry 318 may be instantiated by programmable circuitry such as the example programmable circuitry 1412 of FIG. 14. For instance, the report manager circuitry 318 may be instantiated by the example microprocessor 1500 of FIG. 15 executing machine executable instructions such as those implemented by at least blocks 916 and 918 of FIG. 9. In some examples, report manager circuitry 318 may be instantiated by hardware logic circuitry, which may be implemented by an ASIC, XPU, or the FPGA circuitry 1600 of FIG. 16 configured and/or structured to perform operations corresponding to the machine readable instructions. Additionally or alternatively, the report manager circuitry 318 may be instantiated by any other combination of hardware, software, and/or firmware. For example, the report manager circuitry 318 may be implemented by at least one or more hardware circuits (e.g., processor circuitry, discrete and/or integrated analog and/or digital circuitry, an FPGA, an ASIC, an XPU, a comparator, an operational-amplifier (op-amp), a logic circuit, etc.) configured and/or structured to execute some or all of the machine readable instructions and/or to perform some or all of the operations corresponding to the machine readable instructions without executing software or firmware, but other structures are likewise appropriate.

While an example manner of implementing the performance framework circuitry 330 of FIG. 1 is illustrated in FIG. 3, one or more of the elements, processes, and/or devices illustrated in FIG. 3 may be combined, divided, re-arranged, omitted, eliminated, and/or implemented in any other way. Further, the example test suite generation circuitry 302, the example test data generation circuitry 304, the example test suite execution circuitry 308, example analyzer circuitry 314, the example notification manager circuitry 316, the example report manager circuitry 318, and/or, more generally, the example performance framework circuitry 330 of FIG. 3, may be implemented by hardware alone or by hardware in combination with software and/or firmware. Thus, for example, any of the example test suite generation circuitry 302, the example test data generation circuitry 304, the example test suite execution circuitry 308, example analyzer circuitry 314, the example notification manager circuitry 316, the example report manager circuitry 318, and/or, more generally, the example performance framework circuitry 330, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example performance framework circuitry 330 of FIG. 3 may include one or more elements, processes, and/or devices in addition to, or instead of, those illustrated in FIG. 3, and/or may include more than one of any or all of the illustrated elements, processes and devices.

While an example manner of implementing the test suite generation circuitry 302 of FIG. 3 is illustrated in FIG. 4, one or more of the elements, processes, and/or devices illustrated in FIG. 4 may be combined, divided, re-arranged, omitted, eliminated, and/or implemented in any other way. Further, the example test data generation circuitry 304, the example test suite execution circuitry 308, the example network interface circuitry 402, the example introspection circuitry 404, the example combinatorial generation circuitry 406, the example endpoint processor circuitry 410, the example API processor circuitry 412, the example test suite packaging circuitry 414, and/or, more generally, the example test suite generation circuitry 302 of FIG. 4, may be implemented by hardware alone or by hardware in combination with software and/or firmware. Thus, for example, any of the example test data generation circuitry 304, the example test suite execution circuitry 308, the example network interface circuitry 402, the example introspection circuitry 404, the example combinatorial generation circuitry 406, the example endpoint processor circuitry 410, the example API processor circuitry 412, the example test suite packaging circuitry 414, and/or, more generally, the example test suite generation circuitry 302, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example test suite generation circuitry 302 of FIG. 4 may include one or more elements, processes, and/or devices in addition to, or instead of, those illustrated in FIG. 4, and/or may include more than one of any or all of the illustrated elements, processes and devices.

While an example manner of implementing the analyzer circuitry 314 of FIG. 3 is illustrated in FIG. 5, one or more of the elements, processes, and/or devices illustrated in FIG. 5 may be combined, divided, re-arranged, omitted, eliminated, and/or implemented in any other way. Further, the example test suite execution circuitry 308, the example notification manager circuitry 316, the example report manager circuitry 318, the example network interface circuitry 402, the results analyzer circuitry 502, and/or, more generally, the example analyzer circuitry 314 of FIG. 5, may be implemented by hardware alone or by hardware in combination with software and/or firmware. Thus, for example, any of the example test suite execution circuitry 308, the example notification manager circuitry 316, the example report manager circuitry 318, the example network interface circuitry 402, the results analyzer circuitry 502, and/or, more generally, the example analyzer circuitry 314, could be implemented by programmable circuitry in combination with machine readable instructions (e.g., firmware or software), processor circuitry, analog circuit(s), digital circuit(s), logic circuit(s), programmable processor(s), programmable microcontroller(s), graphics processing unit(s) (GPU(s)), digital signal processor(s) (DSP(s)), ASIC(s), programmable logic device(s) (PLD(s)), and/or field programmable logic device(s) (FPLD(s)) such as FPGAs. Further still, the example analyzer circuitry 314 of FIG. 5 may include one or more elements, processes, and/or devices in addition to, or instead of, those illustrated in FIG. 5, and/or may include more than one of any or all of the illustrated elements, processes and devices.

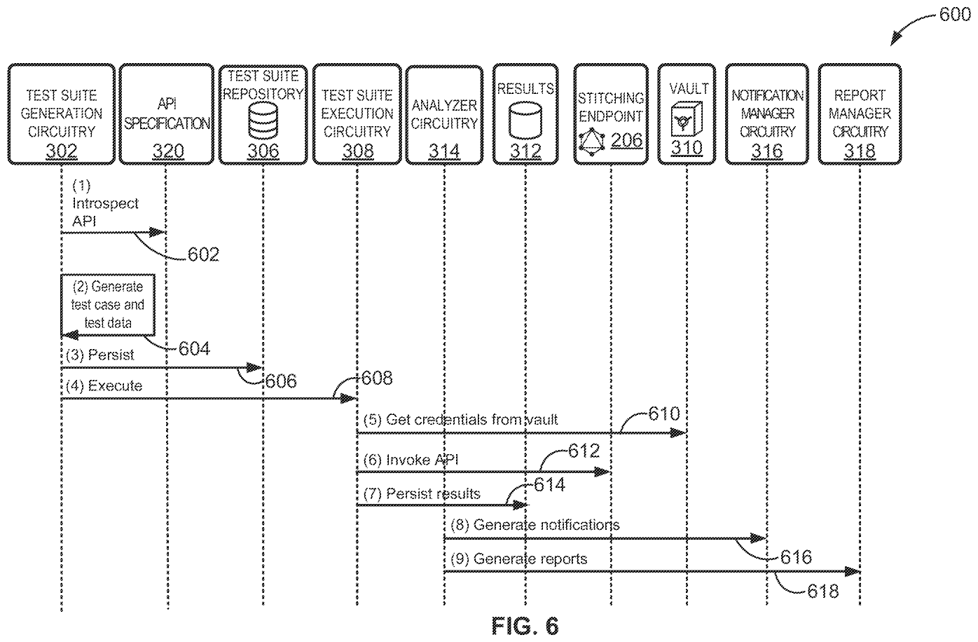

FIG. 6 is an example sequence diagram 600 describing the operation of the performance framework circuitry 330. In the example of FIG. 6, the example test suite generation circuitry 302 introspects on the example API specification 320 with the example introspection circuitry 404 (FIG. 4) at step 602. At step 604, the example test suite generation circuitry 302 generates the test cases with the example combinatorial generation circuitry 406 (FIG. 4) and generates the test data with the test data generation circuitry 304 (FIG. 4). At step 606, the example test suite generation circuitry 302 uses the test suite packaging circuitry 414 (FIG. 4) to package the test cases and test data, the endpoint specification, and the SLA required response times, and the warning threshold times into the first test suite. The example test suite generation circuitry 302 then persists the first test suite in the example test suite repository 306. At step 608, the example test suite generation circuitry 302 uses the example test suite execution circuitry 308 to execute the first test suite on the example stitching endpoint 206.

At step 610, the example test suite execution circuitry 308 accesses the credentials from the example vault 310. The example test suite execution circuitry 308 invokes the API presented by the stitching endpoint 206 at step 612 with the credentials retrieved from the vault 310. The example test suite execution circuitry 308 executes the first test suite on the example stitching endpoint 206. At step 614, the example test suite execution circuitry 308 persists the results in the example results database 312.

At step 616, the example analyzer circuitry 314 uses the notification manager circuitry 316 to generate notifications which are to be sent to the example developers of the microservices that underlie the unified API. At step 618, the example analyzer circuitry 314 uses the report manager circuitry 318 to generate the report.

FIG. 7 is an example pipeline diagram 700 describing the integration of the performance framework circuitry 330 in a build promotion decision 708. In the example pipeline diagram 700, a developer 702 of a microservice (e.g., the user microservice 208, the comment microservice 214, the post microservice, or the address microservice 226 of FIG. 2) updates one of the microservices in the microservice repository 704. The update (e.g., check-in) of the microservice triggers the build and deployment pipeline 706 (e.g., JENKINS™ service) to update the stitching endpoint 206 by deploying the updated microservice. The build and deployment pipeline 706 (e.g., the JENKINS™ service) is an open-source automation server that provides continuous integration and continuous delivery. After deployment, the example performance framework circuitry 330 performs introspection on the stitching endpoint 206 and then executes the test suites against the stitching endpoint 206. The results of the execution of the test suites are used in the build promotion decision 708. For example, the performance framework circuitry 330 informs if the build promotion is to pass or fail based on the actual response times achieving or violating the SLA required response times.

Flowchart(s) representative of example machine readable instructions, which may be executed by programmable circuitry to implement and/or instantiate the performance framework circuitry 330 of FIG. 3, the test suite generation circuitry 302 of FIG. 4, and/or the analyzer circuitry 314 of FIG. 5 and/or representative of example operations which may be performed by programmable circuitry to implement and/or instantiate the performance framework circuitry 330 of FIG. 3, the test suite generation circuitry 302 of FIG. 4, and/or the analyzer circuitry 314 of FIG. 5, are shown in FIGS. 8 and 9. The machine readable instructions may be one or more executable programs or portion(s) of one or more executable programs for execution by programmable circuitry such as the programmable circuitry 1412 shown in the example processor platform 1400 discussed below in connection with FIG. 14 and/or may be one or more function(s) or portion(s) of functions to be performed by the example programmable circuitry (e.g., an FPGA) discussed below in connection with FIGS. 15 and/or 16. In some examples, the machine readable instructions cause an operation, a task, etc., to be carried out and/or performed in an automated manner in the real world. As used herein, “automated” means without human involvement.

The program may be embodied in instructions (e.g., software and/or firmware) stored on one or more non-transitory computer readable and/or machine readable storage medium such as cache memory, a magnetic-storage device or disk (e.g., a floppy disk, a Hard Disk Drive (HDD), etc.), an optical-storage device or disk (e.g., a Blu-ray disk, a Compact Disk (CD), a Digital Versatile Disk (DVD), etc.), a Redundant Array of Independent Disks (RAID), a register, ROM, a solid-state drive (SSD), SSD memory, non-volatile memory (e.g., electrically erasable programmable read-only memory (EEPROM), flash memory, etc.), volatile memory (e.g., Random Access Memory (RAM) of any type, etc.), and/or any other storage device or storage disk. The instructions of the non-transitory computer readable and/or machine readable medium may program and/or be executed by programmable circuitry located in one or more hardware devices, but the entire program and/or parts thereof could alternatively be executed and/or instantiated by one or more hardware devices other than the programmable circuitry and/or embodied in dedicated hardware. The machine readable instructions may be distributed across multiple hardware devices and/or executed by two or more hardware devices (e.g., a server and a client hardware device). For example, the client hardware device may be implemented by an endpoint client hardware device (e.g., a hardware device associated with a human and/or machine user) or an intermediate client hardware device gateway (e.g., a radio access network (RAN)) that may facilitate communication between a server and an endpoint client hardware device. Similarly, the non-transitory computer readable storage medium may include one or more mediums. Further, although the example program is described with reference to the flowchart(s) illustrated in FIGS. 8 and 9, many other methods of implementing the example performance framework circuitry 330 may alternatively be used. For example, the order of execution of the blocks of the flowchart(s) may be changed, and/or some of the blocks described may be changed, eliminated, or combined. Additionally or alternatively, any or all of the blocks of the flow chart may be implemented by one or more hardware circuits (e.g., processor circuitry, discrete and/or integrated analog and/or digital circuitry, an FPGA, an ASIC, a comparator, an operational-amplifier (op-amp), a logic circuit, etc.) structured to perform the corresponding operation without executing software or firmware. The programmable circuitry may be distributed in different network locations and/or local to one or more hardware devices (e.g., a single-core processor (e.g., a single core CPU), a multi-core processor (e.g., a multi-core CPU, an XPU, etc.)). For example, the programmable circuitry may be a CPU and/or an FPGA located in the same package (e.g., the same integrated circuit (IC) package or in two or more separate housings), one or more processors in a single machine, multiple processors distributed across multiple servers of a server rack, multiple processors distributed across one or more server racks, etc., and/or any combination(s) thereof.

The machine readable instructions described herein may be stored in one or more of a compressed format, an encrypted format, a fragmented format, a compiled format, an executable format, a packaged format, etc. Machine readable instructions as described herein may be stored as data (e.g., computer-readable data, machine-readable data, one or more bits (e.g., one or more computer-readable bits, one or more machine-readable bits, etc.), a bitstream (e.g., a computer-readable bitstream, a machine-readable bitstream, etc.), etc.) or a data structure (e.g., as portion(s) of instructions, code, representations of code, etc.) that may be utilized to create, manufacture, and/or produce machine executable instructions. For example, the machine readable instructions may be fragmented and stored on one or more storage devices, disks and/or computing devices (e.g., servers) located at the same or different locations of a network or collection of networks (e.g., in the cloud, in edge devices, etc.). The machine readable instructions may require one or more of installation, modification, adaptation, updating, combining, supplementing, configuring, decryption, decompression, unpacking, distribution, reassignment, compilation, etc., in order to make them directly readable, interpretable, and/or executable by a computing device and/or other machine. For example, the machine readable instructions may be stored in multiple parts, which are individually compressed, encrypted, and/or stored on separate computing devices, wherein the parts when decrypted, decompressed, and/or combined form a set of computer-executable and/or machine executable instructions that implement one or more functions and/or operations that may together form a program such as that described herein.

In another example, the machine readable instructions may be stored in a state in which they may be read by programmable circuitry, but require addition of a library (e.g., a dynamic link library (DLL)), a software development kit (SDK), an application programming interface (API), etc., in order to execute the machine-readable instructions on a particular computing device or other device. In another example, the machine readable instructions may need to be configured (e.g., settings stored, data input, network addresses recorded, etc.) before the machine readable instructions and/or the corresponding program(s) can be executed in whole or in part. Thus, machine readable, computer readable and/or machine readable media, as used herein, may include instructions and/or program(s) regardless of the particular format or state of the machine readable instructions and/or program(s).

The machine readable instructions described herein can be represented by any past, present, or future instruction language, scripting language, programming language, etc. For example, the machine readable instructions may be represented using any of the following languages: C, C++, Java, C#, Perl, Python, JavaScript, HyperText Markup Language (HTML), Structured Query Language (SQL), Swift, etc.

As mentioned above, the example operations of FIGS. 8 and 9 may be implemented using executable instructions (e.g., computer readable and/or machine readable instructions) stored on one or more non-transitory computer readable and/or machine readable media. As used herein, the terms non-transitory computer readable medium, non-transitory computer readable storage medium, non-transitory machine readable medium, and/or non-transitory machine readable storage medium are expressly defined to include any type of computer readable storage device and/or storage disk and to exclude propagating signals and to exclude transmission media. Examples of such non-transitory computer readable medium, non-transitory computer readable storage medium, non-transitory machine readable medium, and/or non-transitory machine readable storage medium include optical storage devices, magnetic storage devices, an HDD, a flash memory, a read-only memory (ROM), a CD, a DVD, a cache, a RAM of any type, a register, and/or any other storage device or storage disk in which information is stored for any duration (e.g., for extended time periods, permanently, for brief instances, for temporarily buffering, and/or for caching of the information). As used herein, the terms “non-transitory computer readable storage device” and “non-transitory machine readable storage device” are defined to include any physical (mechanical, magnetic and/or electrical) hardware to retain information for a time period, but to exclude propagating signals and to exclude transmission media. Examples of non-transitory computer readable storage devices and/or non-transitory machine readable storage devices include random access memory of any type, read only memory of any type, solid state memory, flash memory, optical discs, magnetic disks, disk drives, and/or redundant array of independent disks (RAID) systems. As used herein, the term “device” refers to physical structure such as mechanical and/or electrical equipment, hardware, and/or circuitry that may or may not be configured by computer readable instructions, machine readable instructions, etc., and/or manufactured to execute computer-readable instructions, machine-readable instructions, etc.

“Including” and “comprising” (and all forms and tenses thereof) are used herein to be open ended terms. Thus, whenever a claim employs any form of “include” or “comprise” (e.g., comprises, includes, comprising, including, having, etc.) as a preamble or within a claim recitation of any kind, it is to be understood that additional elements, terms, etc., may be present without falling outside the scope of the corresponding claim or recitation. As used herein, when the phrase “at least” is used as the transition term in, for example, a preamble of a claim, it is open-ended in the same manner as the term “comprising” and “including” are open ended. The term “and/or” when used, for example, in a form such as A, B, and/or C refers to any combination or subset of A, B, C such as (1) A alone, (2) B alone, (3) C alone, (4) A with B, (5) A with C, (6) B with C, or (7) A with B and with C. As used herein in the context of describing structures, components, items, objects and/or things, the phrase “at least one of A and B” is intended to refer to implementations including any of (1) at least one A, (2) at least one B, or (3) at least one A and at least one B. Similarly, as used herein in the context of describing structures, components, items, objects and/or things, the phrase “at least one of A or B” is intended to refer to implementations including any of (1) at least one A, (2) at least one B, or (3) at least one A and at least one B. As used herein in the context of describing the performance or execution of processes, instructions, actions, activities and/or steps, the phrase “at least one of A and B” is intended to refer to implementations including any of (1) at least one A, (2) at least one B, or (3) at least one A and at least one B. Similarly, as used herein in the context of describing the performance or execution of processes, instructions, actions, activities and/or steps, the phrase “at least one of A or B” is intended to refer to implementations including any of (1) at least one A, (2) at least one B, or (3) at least one A and at least one B.

As used herein, singular references (e.g., “a”, “an”, “first”, “second”, etc.) do not exclude a plurality. The term “a” or “an” object, as used herein, refers to one or more of that object. The terms “a” (or “an”), “one or more”, and “at least one” are used interchangeably herein. Furthermore, although individually listed, a plurality of means, elements, or actions may be implemented by, e.g., the same entity or object. Additionally, although individual features may be included in different examples or claims, these may possibly be combined, and the inclusion in different examples or claims does not imply that a combination of features is not feasible and/or advantageous.

FIG. 8 is a flowchart representative of example machine readable instructions and/or example operations 800 that may be executed, instantiated, and/or performed by programmable circuitry to implement test suite generation circuitry of FIGS. 3 and 4 to generate the first test suite. The example machine-readable instructions and/or the example operations 800 of FIG. 8 begin at block 802, at which the test suite generation circuitry 302 retrieves the endpoint specification 324 (FIG. 4). For example, the example test suite generation circuitry 302 (FIG. 3) may retrieve the endpoint specification 324 (FIG. 3) by using the endpoint processor circuitry 410 (FIG. 4). The example test suite generation circuitry 302 (FIG. 3) uses the endpoint specification 324 to determine the location of the stitching endpoint 206 (FIG. 3). Control advances to block 804.

At block 804, the example test suite generation circuitry 302 (FIG. 3) introspects the stitching endpoint 206 (FIG. 3). For example, the test suite generation circuitry 302 (FIG. 3) may introspect the example stitching endpoint 206 (FIG. 3) by using the example introspection circuitry 404. The example test suite generation circuitry 302 introspects the stitching endpoint 206 to determine the organization of the underlying databases of the microservices that the stitching endpoint 206 stitches together. Control advances to block 806.

At block 806, the example test suite generation circuitry 302 (FIG. 3) retrieves the API SLA 322. For example, the test suite generation circuitry 302 (FIG. 3) may retrieve the API SLA 322 by using the example API processor circuitry 412. The example test suite generation circuitry 302 retrieves the API SLA from the developer of the microservice to determine an SLA required response time and to generate a warning response time. Control advances to block 808.

At block 808, the example test suite generation circuitry 302 (FIG. 3) is to process the nodes, queries, and mutations that were uncovered during the introspection. For example, the test suite generation circuitry 302 may process the nodes, queries and mutations by using the example combinatorial generation circuitry 406. The example test suite generation circuitry 302 is to process the nodes, queries, and mutations, to determine the different attributes to be tested with the example test cases. Control advances to block 810.

At block 810, example test suite generation circuitry 302 (FIG. 3) retrieves the attribute from the nodes, queries, and mutations. For example, the example test suite generation circuitry 302 may retrieve the attributes by using the example combinatorial generation circuitry 406. The example test suite generation circuitry 302 is to retrieve the total number of attributes (N) so that the example combinatorial generation circuitry 406 is to generate N factorial (N!) different test cases. Control advances to block 812.

At block 812, the example test suite generation circuitry 302 (FIG. 3) creates node variants, query variants, and mutation variants. For example, the example test suite generation circuitry 302 may use the combinatorial generation circuitry 406 to create the node variants, query variants, and mutation variants. Control advances to block 814.

At block 814, the example test suite generation circuitry 302 (FIG. 3) generates test data. For example, the example test suite generation circuitry 302 may generate the test data by using the example test data generation circuitry 304. The example test data generation circuitry 304 is to use random text generation to generate the test data which may be used in the queries and mutations. Control advances to block 816.

At block 816, the example test suite generation circuitry 302 (FIG. 3) determines if all the attributes are processed. For example, in response to the example test suite generation circuitry 302 determining that all the attributes are processed (e.g., “YES”) control advances to block 818. Alternatively, in response to the example test suite generation circuitry 302 determining that all the attributes were not processed (e.g., “NO”), control returns to block 810. The example test suite generation circuitry 302 may process the example attributes which correspond to the queries and mutations for the different nodes by using the example combinatorial generation circuitry 406.

At block 818, the example test suite generation circuitry 302 (FIG. 3) determines if all the nodes, queries, and mutations have been processed. For example, in response to the example test suite generation circuitry 302 determining that all the nodes, queries, and mutations have been processed (e.g., “YES”), control advances to block 820. Alternatively, in response to the example test suite generation circuitry 302 determining that all the nodes, queries, and mutations have not been processed (e.g., “NO”), control returns to block 808. The example test suite generation circuitry 302 may use the example combinatorial generation circuitry 406 to determine if all the nodes, queries, and mutations have been processed. In some examples, the combinatorial generation circuitry 406 determines if a sub-query that corresponds to a query is also processed.

At block 820, the example test suite generation circuitry 302 (FIG. 3) generates the test suite. For example, the example test suite generation circuitry 302 may generate the test suite by using the example test suite packaging circuitry 414. The example test suite packaging circuitry 414 combines the test cases, the endpoint specification, the SLA required response times, and the warning threshold response times into the first test suite. Control advances to block 822.

At block 822, the example test suite generation circuitry 302 persists the test suite in a test suite repository 306 (FIG. 3). For example, the example test suite generation circuitry 302 may persist the test suite by in the example test suite repository 306 (FIG. 3) by using the example test suite packaging circuitry 414 or the example network interface circuitry 402. The instructions 800 end.

FIG. 9 is a flowchart representative of example machine readable instructions and/or example operations that may be executed, instantiated, and/or performed by example programmable circuitry to implement the analyzer circuitry of FIGS. 3 and 5 to analyze the test suite execution results. The example machine-readable instructions and/or the example operations 900 of FIG. 9 begin at block 902, at which the example test suite execution circuitry 308 access credentials from the example vault 310. For example, the test suite execution circuitry 308 (FIG. 3) may access the credentials from the example vault 310 by using the access token from the endpoint specification 324 (FIG. 3) which is saved in the example first test suite. Control advances to block 904.

At block 904, the example test suite execution circuitry 308 (FIG. 3) executes a first test suite with an automated query language endpoint such as the stitching endpoint 206 (FIG. 3). For example, the test suite execution circuitry 308 (FIG. 3) may execute the first test suite with a GraphQL endpoint. Control advances to block 906.

At block 906, the example test suite execution circuitry 308 (FIG. 3) retrieves the SLA results from the first executed test suite. For example, the test suite execution circuitry 308 (FIG. 3) may retrieve the SLA results by recording the actual response times from the execution of the queries and mutations for the nodes. Control advances to block 908.

At block 908, the example test suite execution circuitry 308 (FIG. 3) persists the SLA results (e.g., actual response times) in an example results database 312 (FIG. 3). The example test suite execution circuitry 308 (FIG. 3) may persist the SLA results in an example results database 312 by writing the actual response times of the execution to memory in the example results database 312. In some examples, the test suite execution circuitry 308 may transmit the actual response times to the example analyzer circuitry 314 (FIG. 3).

At block 910, the example analyzer circuitry 314 (FIG. 3) analyzes the SLA results. For example, the example analyzer circuitry 314 (FIG. 3) may analyze the SLA results by using the example results analyzer circuitry 502 (FIG. 5) by determining the response time and the corresponding amount of data that was requested by the query. In some examples, the analyzer circuitry 314 determines potential reasons for the different response times. In other examples, by performing a first query of person data and address data, and performing a second query of address data and device data, the analyzer circuitry 314 extrapolates the response times of the first query and the second query to determine the expected latency for requesting only the person data. Control advances to block 912.

At block 912, the example analyzer circuitry 314 (FIG. 3) compares the SLA results with a threshold. For example, the example analyzer circuitry 314 (FIG. 3) may compare the actual response times with the SLA required response times and the warning threshold times. For example, if the SLA required response time is five thousand milliseconds, and the warning threshold response time is four thousand milliseconds, the example analyzer circuitry 314 may compare the actual response time of six thousand milliseconds to the SLA required response time and the warning threshold response time. In some examples, the longest response time for the different microservices is recorded as the actual response time and compared to the SLA required response time and the warning threshold response time. In other examples, each response time for the different microservices is recorded as an individual actual response time, and each of these individual actual response times is compared to the SLA required response time and the warning threshold response time. Control advances to block 914.

At block 914, the example analyzer circuitry 314 (FIG. 3) determines if the SLA results satisfy the threshold. For example, in response to the analyzer circuitry 314 determining that the SLA results satisfies the threshold (e.g., “YES”), control advances to block 918. Alternatively, in response to the analyzer circuitry 314 determining that the SLA results did not satisfy the threshold (e.g., “NO”), control advances to block 916. The example threshold may be either the warning threshold (e.g., four thousand milliseconds) or the SLA requirement (e.g., five thousand milliseconds).

At block 916, the example analyzer circuitry 314 (FIG. 3) generates a report that the SLA results did not satisfy the threshold (e.g., the SLA requirement or the warning threshold). For example, the example analyzer circuitry 314 (FIG. 3) may generate a report by using the example report manager circuitry 318. Control advances to block 920.

At block 918, the example analyzer circuitry 314 (FIG. 3) generates a report that the SLA results satisfied the threshold (e.g., the SLA requirement or the warning threshold). For example, the example analyzer circuitry 314 (FIG. 3) may generate the report that the SLA results satisfied the threshold by using the example report manager circuitry 318. Control advances to block 922.

At block 920, the example analyzer circuitry 314 (FIG. 3) notifies a developer of a microservice that the response time corresponding to the microservice did not satisfy the threshold (e.g., the SLA requirement or the warning threshold). For example, the example analyzer circuitry 314 (FIG. 3) may notify the developer of the microservice by using the example notification management circuitry 316. In some examples, the notification management circuitry 316 informs the deployment pipeline 706 (FIG. 7) to either pass or fail the build promotion decision 708 (FIG. 7). Control advances to block 922.

At block 922, the example analyzer circuitry 314 (FIG. 3) determines if there is another test suite to execute. For example, in response to analyzer circuitry 314 determining that there another test suite to execute (e.g., “YES”), control returns to block 902. Alternatively, in response to the example analyzer circuitry 314 determining that there is not another test suite to execute (e.g. “NO”), the instructions 900 end. The example analyzer circuitry 314 may determine that there is another test suite by using the example test suite execution circuitry 308 to check to the test suite repository 306. In some examples, the example analyzer circuitry 314 may determine that there is another test suite in response to a notification from a developer of a microservice, that the microservice has been updated.

FIG. 10 is a representative of example results generated by the test suite execution circuitry of FIG. 3 and analyzed by the example analyzer circuitry of FIGS. 3 and 5. As shown in FIG. 10, the test suite includes two test cases. The example first test case 1002 has an SLA required response time of five thousand milliseconds, a warning threshold of four thousand and five hundred milliseconds. The actual response time is six thousand milliseconds and violated both the SLA required response time and the warning threshold. The example second test case 1004 has an SLA required response time of five thousand milliseconds, a warning threshold of four thousand and five hundred milliseconds. The actual response time is three thousand and five hundred milliseconds and achieved both the SLA required response time and the warning threshold.

FIG. 11 is a database representation of an application programming interface (API) specification that is introspected upon by the example test suite generation circuitry of FIGS. 3 and 4. As shown in FIG. 11, there are five different types. The example API specification 320 includes a query 1102, a mutation 1104, a user node 1106, a post node 1108, and a comment node 1110. The example query 1102 is used to access or retrieve data. The example mutation 1104 is used to edit the data in the example databases. The example user node 1106 may correspond to the example user database 212 (FIG. 2) which is in the example user microservice 208 (FIG. 2) and accessible by the example user endpoint 210 (FIG. 2). The example post node 1108 may correspond to the example post database 224 (FIG. 2), which is in the example post microservice 220 (FIG. 2) and accessible by the example post endpoint 222 (FIG. 2). The example comment node 1110 may correspond to the example comment database 218 (FIG. 2), which is in the example comment microservice 214 (FIG. 2) and accessible by the example comment endpoint 216 (FIG. 2). In the example of FIG. 11, the example combinatorial generation circuitry 406 (FIG. 4) uses the nodes, mutations, and queries are used to determine the number of attributes.

FIG. 12 is a database representation of an API service level agreement (SLA) 322 that is used by the example test suite generation circuitry of FIGS. 3 and 4. As shown in FIG. 12, the SLA required response time is five thousand milliseconds for the using the queries and mutations for the different nodes of the different microservices. The example test suite generation circuitry 302 (FIG. 3) is to determine warning threshold response times based on the SLA required response times in the API SLA 322.

FIG. 13 is a database representation of an endpoint specification 324 that is used by the example test suite generation circuitry of FIG. 3. The example endpoint specification 324 includes an authorization token and a location (e.g., URL) for the stitching endpoint 206 (FIG. 2).

FIG. 14 is a block diagram of an example programmable circuitry platform 1400 structured to execute and/or instantiate the example machine-readable instructions and/or the example operations of FIGS. 8 and 9 to implement the performance framework circuitry 330 of FIG. 3, the test suite generation circuitry 302 of FIG. 4, and/or the analyzer circuitry 314 of FIG. 5. The programmable circuitry platform 1400 can be, for example, a server, a personal computer, a workstation, a self-learning machine (e.g., a neural network), a mobile device (e.g., a cell phone, a smart phone, a tablet such as an iPad™), a personal digital assistant (PDA), an Internet appliance, a headset (e.g., an augmented reality (AR) headset, a virtual reality (VR) headset, etc.) or other wearable device, or any other type of computing and/or electronic device.

The programmable circuitry platform 1400 of the illustrated example includes programmable circuitry 1412. The programmable circuitry 1412 of the illustrated example is hardware. For example, the programmable circuitry 1412 can be implemented by one or more integrated circuits, logic circuits, FPGAs, microprocessors, CPUs, GPUs, DSPs, and/or microcontrollers from any desired family or manufacturer. The programmable circuitry 1412 may be implemented by one or more semiconductor based (e.g., silicon based) devices. In this example, the programmable circuitry 1412 implements the example test suite generation circuitry 302, the example test data generation circuitry 304, the example test suite execution circuitry 308, the example analyzer circuitry 314, the example notification manager circuitry 316, the example report manager circuitry 318, the example network interface circuitry 402, the example introspection circuitry 404, the example combinatorial generation circuitry 406, the example endpoint processor circuitry 410, the example API processor circuitry 412, the example test suite packaging circuitry 414, and the example results analyzer circuitry 502.

The programmable circuitry 1412 of the illustrated example includes a local memory 1413 (e.g., a cache, registers, etc.). The programmable circuitry 1412 of the illustrated example is in communication with main memory 1414, 1416, which includes a volatile memory 1414 and a non-volatile memory 1416, by a bus 1418. The volatile memory 1414 may be implemented by Synchronous Dynamic Random Access Memory (SDRAM), Dynamic Random Access Memory (DRAM), RAMBUS® Dynamic Random Access Memory (RDRAM®), and/or any other type of RAM device. The non-volatile memory 1416 may be implemented by flash memory and/or any other desired type of memory device. Access to the main memory 1414, 1416 of the illustrated example is controlled by a memory controller 1417. In some examples, the memory controller 1417 may be implemented by one or more integrated circuits, logic circuits, microcontrollers from any desired family or manufacturer, or any other type of circuitry to manage the flow of data going to and from the main memory 1414, 1416.

The programmable circuitry platform 1400 of the illustrated example also includes interface circuitry 1420. The interface circuitry 1420 may be implemented by hardware in accordance with any type of interface standard, such as an Ethernet interface, a universal serial bus (USB) interface, a Bluetooth® interface, a near field communication (NFC) interface, a Peripheral Component Interconnect (PCI) interface, and/or a Peripheral Component Interconnect Express (PCIe) interface.

In the illustrated example, one or more input devices 1422 are connected to the interface circuitry 1420. The input device(s) 1422 permit(s) a user (e.g., a human user, a machine user, etc.) to enter data and/or commands into the programmable circuitry 1412. The input device(s) 1422 can be implemented by, for example, an audio sensor, a microphone, a camera (still or video), a keyboard, a button, a mouse, a touchscreen, a trackpad, a trackball, an isopoint device, and/or a voice recognition system.

One or more output devices 1424 are also connected to the interface circuitry 1420 of the illustrated example. The output device(s) 1424 can be implemented, for example, by display devices (e.g., a light emitting diode (LED), an organic light emitting diode (OLED), a liquid crystal display (LCD), a cathode ray tube (CRT) display, an in-place switching (IPS) display, a touchscreen, etc.), a tactile output device, a printer, and/or speaker. The interface circuitry 1420 of the illustrated example, thus, typically includes a graphics driver card, a graphics driver chip, and/or graphics processor circuitry such as a GPU.

The interface circuitry 1420 of the illustrated example also includes a communication device such as a transmitter, a receiver, a transceiver, a modem, a residential gateway, a wireless access point, and/or a network interface to facilitate exchange of data with external machines (e.g., computing devices of any kind) by a network 1426. The communication can be by, for example, an Ethernet connection, a digital subscriber line (DSL) connection, a telephone line connection, a coaxial cable system, a satellite system, a beyond-line-of-sight wireless system, a line-of-sight wireless system, a cellular telephone system, an optical connection, etc.

The programmable circuitry platform 1400 of the illustrated example also includes one or more mass storage discs or devices 1428 to store firmware, software, and/or data. Examples of such mass storage discs or devices 1428 include magnetic storage devices (e.g., floppy disk, drives, HDDs, etc.), optical storage devices (e.g., Blu-ray disks, CDs, DVDs, etc.), RAID systems, and/or solid-state storage discs or devices such as flash memory devices and/or SSDs.

The machine readable instructions 1432, which may be implemented by the machine readable instructions of FIGS. 8 and 9, may be stored in the mass storage device 1428, in the volatile memory 1414, in the non-volatile memory 1416, and/or on at least one non-transitory computer readable storage medium such as a CD or DVD which may be removable.

FIG. 15 is a block diagram of an example implementation of the programmable circuitry 1412 of FIG. 14. In this example, the programmable circuitry 1412 of FIG. 14 is implemented by a microprocessor 1500. For example, the microprocessor 1500 may be a general-purpose microprocessor (e.g., general-purpose microprocessor circuitry). The microprocessor 1500 executes some or all of the machine-readable instructions of the flowcharts of FIGS. 8 and 9 to effectively instantiate the circuitry of FIG. 2 as logic circuits to perform operations corresponding to those machine readable instructions. In some such examples, the circuitry of FIG. 3 is instantiated by the hardware circuits of the microprocessor 1500 in combination with the machine-readable instructions. For example, the microprocessor 1500 may be implemented by multi-core hardware circuitry such as a CPU, a DSP, a GPU, an XPU, etc. Although it may include any number of example cores 1502 (e.g., 1 core), the microprocessor 1500 of this example is a multi-core semiconductor device including N cores. The cores 1502 of the microprocessor 1500 may operate independently or may cooperate to execute machine readable instructions. For example, machine code corresponding to a firmware program, an embedded software program, or a software program may be executed by one of the cores 1502 or may be executed by multiple ones of the cores 1502 at the same or different times. In some examples, the machine code corresponding to the firmware program, the embedded software program, or the software program is split into threads and executed in parallel by two or more of the cores 1502. The software program may correspond to a portion or all of the machine readable instructions and/or operations represented by the flowcharts of FIGS. 8 and 9.

The cores 1502 may communicate by a first example bus 1504. In some examples, the first bus 1504 may be implemented by a communication bus to effectuate communication associated with one(s) of the cores 1502. For example, the first bus 1504 may be implemented by at least one of an Inter-Integrated Circuit (I2C) bus, a Serial Peripheral Interface (SPI) bus, a PCI bus, or a PCIe bus. Additionally or alternatively, the first bus 1504 may be implemented by any other type of computing or electrical bus. The cores 1502 may obtain data, instructions, and/or signals from one or more external devices by example interface circuitry 1506. The cores 1502 may output data, instructions, and/or signals to the one or more external devices by the interface circuitry 1506. Although the cores 1502 of this example include example local memory 1520 (e.g., Level 1 (L1) cache that may be split into an L1 data cache and an L1 instruction cache), the microprocessor 1500 also includes example shared memory 1510 that may be shared by the cores (e.g., Level 2 (L2 cache)) for high-speed access to data and/or instructions. Data and/or instructions may be transferred (e.g., shared) by writing to and/or reading from the shared memory 1510. The local memory 1520 of each of the cores 1502 and the shared memory 1510 may be part of a hierarchy of storage devices including multiple levels of cache memory and the main memory (e.g., the main memory 1414, 1416 of FIG. 14). Typically, higher levels of memory in the hierarchy exhibit lower access time and have smaller storage capacity than lower levels of memory. Changes in the various levels of the cache hierarchy are managed (e.g., coordinated) by a cache coherency policy.

Each core 1502 may be referred to as a CPU, DSP, GPU, etc., or any other type of hardware circuitry. Each core 1502 includes control unit circuitry 1514, arithmetic and logic (AL) circuitry (sometimes referred to as an ALU) 1516, a plurality of registers 1518, the local memory 1520, and a second example bus 1522. Other structures may be present. For example, each core 1502 may include vector unit circuitry, single instruction multiple data (SIMD) unit circuitry, load/store unit (LSU) circuitry, branch/jump unit circuitry, floating-point unit (FPU) circuitry, etc. The control unit circuitry 1514 includes semiconductor-based circuits structured to control (e.g., coordinate) data movement within the corresponding core 1502. The AL circuitry 1516 includes semiconductor-based circuits structured to perform one or more mathematic and/or logic operations on the data within the corresponding core 1502. The AL circuitry 1516 of some examples performs integer based operations. In other examples, the AL circuitry 1516 also performs floating-point operations. In yet other examples, the AL circuitry 1516 may include first AL circuitry that performs integer-based operations and second AL circuitry that performs floating-point operations. In some examples, the AL circuitry 1516 may be referred to as an Arithmetic Logic Unit (ALU).

The registers 1518 are semiconductor-based structures to store data and/or instructions such as results of one or more of the operations performed by the AL circuitry 1516 of the corresponding core 1502. For example, the registers 1518 may include vector register(s), SIMD register(s), general-purpose register(s), flag register(s), segment register(s), machine-specific register(s), instruction pointer register(s), control register(s), debug register(s), memory management register(s), machine check register(s), etc. The registers 1518 may be arranged in a bank as shown in FIG. 15. Alternatively, the registers 1518 may be organized in any other arrangement, format, or structure, such as by being distributed throughout the core 1502 to shorten access time. The second bus 1522 may be implemented by at least one of an I2C bus, a SPI bus, a PCI bus, or a PCIe bus.

Each core 1502 and/or, more generally, the microprocessor 1500 may include additional and/or alternate structures to those shown and described above. For example, one or more clock circuits, one or more power supplies, one or more power gates, one or more cache home agents (CHAs), one or more converged/common mesh stops (CMSs), one or more shifters (e.g., barrel shifter(s)) and/or other circuitry may be present. The microprocessor 1500 is a semiconductor device fabricated to include many transistors interconnected to implement the structures described above in one or more integrated circuits (ICs) contained in one or more packages.

The microprocessor 1500 may include and/or cooperate with one or more accelerators (e.g., acceleration circuitry, hardware accelerators, etc.). In some examples, accelerators are implemented by logic circuitry to perform certain tasks more quickly and/or efficiently than can be done by a general-purpose processor. Examples of accelerators include ASICs and FPGAs such as those discussed herein. A GPU, DSP and/or other programmable device can also be an accelerator. Accelerators may be on-board the microprocessor 1500, in the same chip package as the microprocessor 1500 and/or in one or more separate packages from the microprocessor 1500.

FIG. 16 is a block diagram of another example implementation of the programmable circuitry 1412 of FIG. 14. In this example, the programmable circuitry 1412 is implemented by FPGA circuitry 1600. For example, the FPGA circuitry 1600 may be implemented by an FPGA. The FPGA circuitry 1600 can be used, for example, to perform operations that could otherwise be performed by the example microprocessor 1500 of FIG. 15 executing corresponding machine readable instructions. However, once configured, the FPGA circuitry 1600 instantiates the operations and/or functions corresponding to the machine readable instructions in hardware and, thus, can often execute the operations/functions faster than they could be performed by a general-purpose microprocessor executing the corresponding software.

More specifically, in contrast to the microprocessor 1500 of FIG. 15 described above (which is a general purpose device that may be programmed to execute some or all of the machine readable instructions represented by the flowchart(s) of FIGS. 8 and 9 but whose interconnections and logic circuitry are fixed once fabricated), the FPGA circuitry 1600 of the example of FIG. 16 includes interconnections and logic circuitry that may be configured, structured, programmed, and/or interconnected in different ways after fabrication to instantiate, for example, some or all of the operations/functions corresponding to the machine readable instructions represented by the flowchart(s) of FIGS. 8 and 9. In particular, the FPGA circuitry 1600 may be thought of as an array of logic gates, interconnections, and switches. The switches can be programmed to change how the logic gates are interconnected by the interconnections, effectively forming one or more dedicated logic circuits (unless and until the FPGA circuitry 1600 is reprogrammed). The configured logic circuits enable the logic gates to cooperate in different ways to perform different operations on data received by input circuitry. Those operations may correspond to some or all of the instructions (e.g., the software and/or firmware) represented by the flowchart(s) of FIGS. 8 and 9. As such, the FPGA circuitry 1600 may be configured and/or structured to effectively instantiate some or all of the operations/functions corresponding to the machine readable instructions of the flowchart(s) of FIGS. 8 and 9 as dedicated logic circuits to perform the operations/functions corresponding to those software instructions in a dedicated manner analogous to an ASIC. Therefore, the FPGA circuitry 1600 may perform the operations/functions corresponding to the some or all of the machine readable instructions of FIGS. 8 and 9 faster than the general-purpose microprocessor can execute the same.

In the example of FIG. 16, the FPGA circuitry 1600 is configured and/or structured in response to being programmed (and/or reprogrammed one or more times) based on a binary file. In some examples, the binary file may be compiled and/or generated based on instructions in a hardware description language (HDL) such as Lucid, Very High Speed Integrated Circuits (VHSIC) Hardware Description Language (VHDL), or Verilog. For example, a user (e.g., a human user, a machine user, etc.) may write code or a program corresponding to one or more operations/functions in an HDL; the code/program may be translated into a low-level language as needed; and the code/program (e.g., the code/program in the low-level language) may be converted (e.g., by a compiler, a software application, etc.) into the binary file. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

In some examples, the binary file is compiled, generated, transformed, and/or otherwise output from a uniform software platform utilized to program FPGAs. For example, the uniform software platform may translate first instructions (e.g., code or a program) that correspond to one or more operations/functions in a high-level language (e.g., C, C++, Python, etc.) into second instructions that correspond to the one or more operations/functions in an HDL. In some such examples, the binary file is compiled, generated, and/or otherwise output from the uniform software platform based on the second instructions. In some examples, the FPGA circuitry 1600 of FIG. 16 may access and/or load the binary file to cause the FPGA circuitry 1600 of FIG. 16 to be configured and/or structured to perform the one or more operations/functions. For example, the binary file may be implemented by a bit stream (e.g., one or more computer-readable bits, one or more machine-readable bits, etc.), data (e.g., computer-readable data, machine-readable data, etc.), and/or machine-readable instructions accessible to the FPGA circuitry 1600 of FIG. 16 to cause configuration and/or structuring of the FPGA circuitry 1600 of FIG. 16, or portion(s) thereof.

The FPGA circuitry 1600 of FIG. 16, includes example input/output (I/O) circuitry 1602 to obtain and/or output data to/from example configuration circuitry 1604 and/or external hardware 1606. For example, the configuration circuitry 1604 may be implemented by interface circuitry that may obtain a binary file, which may be implemented by a bit stream, data, and/or machine-readable instructions, to configure the FPGA circuitry 1600, or portion(s) thereof. In some such examples, the configuration circuitry 1604 may obtain the binary file from a user, a machine (e.g., hardware circuitry (e.g., programmable or dedicated circuitry) that may implement an Artificial Intelligence/Machine Learning (AI/ML) model to generate the binary file), etc., and/or any combination(s) thereof). In some examples, the external hardware 1606 may be implemented by external hardware circuitry. For example, the external hardware 1606 may be implemented by the microprocessor 1500 of FIG. 15.

The FPGA circuitry 1600 also includes an array of example logic gate circuitry 1608, a plurality of example configurable interconnections 1610, and example storage circuitry 1612. The logic gate circuitry 1608 and the configurable interconnections 1610 are configurable to instantiate one or more operations/functions that may correspond to at least some of the machine readable instructions of FIGS. 8 and 9 and/or other desired operations. The logic gate circuitry 1608 shown in FIG. 16 is fabricated in blocks or groups. Each block includes semiconductor-based electrical structures that may be configured into logic circuits. In some examples, the electrical structures include logic gates (e.g., And gates, Or gates, Nor gates, etc.) that provide basic building blocks for logic circuits. Electrically controllable switches (e.g., transistors) are present within each of the logic gate circuitry 1608 to enable configuration of the electrical structures and/or the logic gates to form circuits to perform desired operations/functions. The logic gate circuitry 1608 may include other electrical structures such as look-up tables (LUTs), registers (e.g., flip-flops or latches), multiplexers, etc.

The configurable interconnections 1610 of the illustrated example are conductive pathways, traces, vias, or the like that may include electrically controllable switches (e.g., transistors) whose state can be changed by programming (e.g., using an HDL instruction language) to activate or deactivate one or more connections between one or more of the logic gate circuitry 1608 to program desired logic circuits.

The storage circuitry 1612 of the illustrated example is structured to store result(s) of the one or more of the operations performed by corresponding logic gates. The storage circuitry 1612 may be implemented by registers or the like. In the illustrated example, the storage circuitry 1612 is distributed amongst the logic gate circuitry 1608 to facilitate access and increase execution speed.

The example FPGA circuitry 1600 of FIG. 16 also includes example dedicated operations circuitry 1614. In this example, the dedicated operations circuitry 1614 includes special purpose circuitry 1616 that may be invoked to implement commonly used functions to avoid the need to program those functions in the field. Examples of such special purpose circuitry 1616 include memory (e.g., DRAM) controller circuitry, PCIe controller circuitry, clock circuitry, transceiver circuitry, memory, and multiplier-accumulator circuitry. Other types of special purpose circuitry may be present. In some examples, the FPGA circuitry 1600 may also include example general purpose programmable circuitry 1618 such as an example CPU 1620 and/or an example DSP 1622. Other general purpose programmable circuitry 1618 may additionally or alternatively be present such as a GPU, an XPU, etc., that can be programmed to perform other operations.

Although FIGS. 15 and 16 illustrate two example implementations of the programmable circuitry 1412 of FIG. 14, many other approaches are contemplated. For example, FPGA circuitry may include an on-board CPU, such as one or more of the example CPU 1620 of FIG. 15. Therefore, the programmable circuitry 1412 of FIG. 14 may additionally be implemented by combining at least the example microprocessor 1500 of FIG. 15 and the example FPGA circuitry 1600 of FIG. 16. In some such hybrid examples, one or more cores 1502 of FIG. 15 may execute a first portion of the machine readable instructions represented by the flowchart(s) of FIGS. 8 and 9 to perform first operation(s)/function(s), the FPGA circuitry 1600 of FIG. 16 may be configured and/or structured to perform second operation(s)/function(s) corresponding to a second portion of the machine readable instructions represented by the flowcharts of FIGS. 8 and 9, and/or an ASIC may be configured and/or structured to perform third operation(s)/function(s) corresponding to a third portion of the machine readable instructions represented by the flowcharts of FIGS. 8 and 9.

It should be understood that some or all of the circuitry of FIG. 3 may, thus, be instantiated at the same or different times. For example, same and/or different portion(s) of the microprocessor 1500 of FIG. 15 may be programmed to execute portion(s) of machine-readable instructions at the same and/or different times. In some examples, same and/or different portion(s) of the FPGA circuitry 1600 of FIG. 16 may be configured and/or structured to perform operations/functions corresponding to portion(s) of machine-readable instructions at the same and/or different times.

In some examples, some or all of the circuitry of FIG. 3 may be instantiated, for example, in one or more threads executing concurrently and/or in series. For example, the microprocessor 1500 of FIG. 15 may execute machine readable instructions in one or more threads executing concurrently and/or in series. In some examples, the FPGA circuitry 1600 of FIG. 16 may be configured and/or structured to carry out operations/functions concurrently and/or in series. Moreover, in some examples, some or all of the circuitry of FIG. 3 may be implemented within one or more virtual machines and/or containers executing on the microprocessor 1500 of FIG. 15.

In some examples, the programmable circuitry 1412 of FIG. 14 may be in one or more packages. For example, the microprocessor 1500 of FIG. 15 and/or the FPGA circuitry 1600 of FIG. 16 may be in one or more packages. In some examples, an XPU may be implemented by the programmable circuitry 1412 of FIG. 14, which may be in one or more packages. For example, the XPU may include a CPU (e.g., the microprocessor 1500 of FIG. 15, the CPU 1620 of FIG. 16, etc.) in one package, a DSP (e.g., the DSP 1622 of FIG. 16) in another package, a GPU in yet another package, and an FPGA (e.g., the FPGA circuitry 1600 of FIG. 16) in still yet another package.

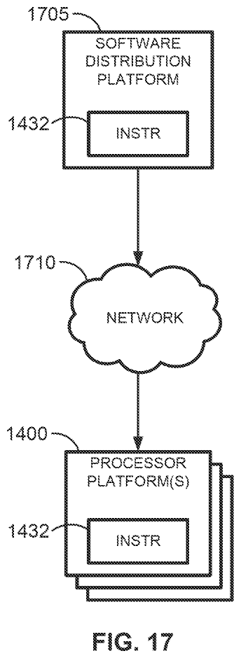

A block diagram illustrating an example software distribution platform 1705 to distribute software such as the example machine readable instructions 1432 of FIG. 14 to other hardware devices (e.g., hardware devices owned and/or operated by third parties from the owner and/or operator of the software distribution platform) is illustrated in FIG. 17. The example software distribution platform 1705 may be implemented by any computer server, data facility, cloud service, etc., capable of storing and transmitting software to other computing devices. The third parties may be customers of the entity owning and/or operating the software distribution platform 1705. For example, the entity that owns and/or operates the software distribution platform 1705 may be a developer, a seller, and/or a licensor of software such as the example machine readable instructions 1432 of FIG. 14. The third parties may be consumers, users, retailers, OEMs, etc., who purchase and/or license the software for use and/or re-sale and/or sub-licensing. In the illustrated example, the software distribution platform 1705 includes one or more servers and one or more storage devices. The storage devices store the machine readable instructions 1432, which may correspond to the example machine readable instructions of FIGS. 8 and 9, as described above. The one or more servers of the example software distribution platform 1705 are in communication with an example network 1710, which may correspond to any one or more of the Internet and/or any of the example networks described above. In some examples, the one or more servers are responsive to requests to transmit the software to a requesting party as part of a commercial transaction. Payment for the delivery, sale, and/or license of the software may be handled by the one or more servers of the software distribution platform and/or by a third party payment entity. The servers enable purchasers and/or licensors to download the machine readable instructions 1432 from the software distribution platform 1705. For example, the software, which may correspond to the example machine readable instructions of FIGS. 8 and 9, may be downloaded to the example programmable circuitry platform 1400, which is to execute the machine readable instructions 1432 to implement the performance framework circuitry 330. In some examples, one or more servers of the software distribution platform 1705 periodically offer, transmit, and/or force updates to the software (e.g., the example machine readable instructions 1432 of FIG. 14) to ensure improvements, patches, updates, etc., are distributed and applied to the software at the end user devices. Although referred to as software above, the distributed “software” could alternatively be firmware.

From the foregoing, it will be appreciated that example systems, apparatus, articles of manufacture, and methods have been disclosed that determine the performance of deployed microservices by testing a stitching endpoint of an automated query language. Disclosed systems, apparatus, articles of manufacture, and methods improve the efficiency of using a computing device by notifying a developer that an update to an underlying microservice has altered the overall response time of the unified API. By notifying the developer, computer resources are not wasted in deploying the updated microservice which violates response times. The techniques disclosed herein evaluate the performance of the individual endpoints (e.g., the user endpoint 210, the comment endpoint 216, the post endpoint 222, and the address endpoint 228) by generating test suites, executing the test suites, and then analyzing the results that correspond to the executed test suites. The different test suites request different data from a variety of databases and test the possible combinations of the data that could be selected. In some examples, the results that correspond to the executed test suites are used to determine if the SLA was not reached and to notify the developers responsible for managing the service. Disclosed systems, apparatus, articles of manufacture, and methods are accordingly directed to one or more improvement(s) in the operation of a machine such as a computer or other electronic and/or mechanical device.

Example methods, apparatus, systems, and articles of manufacture to test an automated query language are disclosed herein. Further examples and combinations thereof include the following: Example 1 includes an apparatus to test an automated query language, the apparatus comprising network communication circuitry to interface with a query endpoint, test suite generation circuitry to generate a first test suite based on a plurality of combinations of a plurality of attributes corresponding to an API specification, test suite execution circuitry to transmit the first test suite to be executed on the query endpoint, the first test suite to include instructions to cause the query endpoint to access data stored in a database accessible to a plurality of secondary endpoints, and analyzer circuitry to obtain a response time corresponding to the access of the data, compare the response time corresponding to the access of the data with a service level agreement required response time, and in response to the response time corresponding to the access of the data being longer than the service level agreement required response time, notify a developer of the plurality of secondary endpoints.

Example 2 includes the apparatus of example 1, wherein in response to the response time corresponding to the access of the data is longer than the service level agreement required response time, the analyzer circuitry is to cancel a deployment of the plurality of the secondary endpoints.

Example 3 includes the apparatus of example 1, wherein the analyzer circuitry is to compare the response time to a warning threshold time, the warning threshold time shorter than the service level agreement required response time.

Example 4 includes the apparatus of example 3, wherein the analyzer circuitry is to generate a report which lists the response time, the warning threshold time, and the service level agreement required response time.

Example 5 includes the apparatus of example 1, wherein the test suite execution circuitry is to transmit the test suite to the query endpoint in response to a notification corresponding to an update in one of the plurality of secondary endpoints.

Example 6 includes the apparatus of example 1, wherein the plurality of secondary endpoints correspond to a plurality of microservices.

Example 7 includes the apparatus of example 6, wherein the query endpoint corresponds to a stitching endpoint that stitches the plurality of microservices together into a unified application programming interface.

Example 8 includes the apparatus of example 1, wherein the test suite is composed of a plurality of test cases.

Example 9 includes the apparatus of example 8, wherein a first test case in the plurality of test cases is to test a first group of attributes of the plurality of secondary endpoints.

Example 10 includes the apparatus of example 1, wherein the test suite execution circuitry is to retrieve credentials from a vault, the credentials to access the query endpoint.

Example 11 includes the apparatus of example 1, wherein the test suite execution circuitry is further to retrieve the test suite from a test suite repository.

Example 12 includes an apparatus to generate test suites, the apparatus comprising network interface circuitry to, in response to a notification that a first microservice of a plurality of microservices is updated, retrieve an application programming interface (API) specification of the plurality of microservices, introspection circuitry to determine attributes that are present in the API specification, combinatorial generation circuitry to generate a plurality of test cases based on the determined attributes, and test suite packaging circuitry to package the plurality of test cases as a first test suite.

Example 13 includes the apparatus of example 12, wherein the introspection circuitry is to determine a number of queries and mutations present in the API specification.

Example 14 includes the apparatus of example 13, wherein the queries and the mutations correspond to different ones of the plurality of microservices.

Example 15 includes the apparatus of example 13, wherein the queries and the mutations correspond to different nodes of the API specification.

Example 16 includes the apparatus of example 13, wherein the introspection circuitry is further to determine an organization of the attributes that are present in the API specification.

Example 17 includes the apparatus of example 16, further including test data generation circuitry, the test data generation circuitry to generate sample data that follows the organization of the attributes.

Example 18 includes the apparatus of example 17, wherein the test data generation circuitry generates the test data by using random text generation, random unique user identifiers generation, random email address generation, and random number generation.

Example 19 includes the apparatus of example 18, wherein the test data is used with ones of the mutations to update data in a database in one of the plurality of microservices.

Example 20 includes the apparatus of example 12, wherein the combinatorial generation circuitry is to generate N factorial test cases, where N corresponds to a number of the determined attributes.

Example 21 includes the apparatus of example 12, further including endpoint processor circuitry to process an endpoint specification to determine a location corresponding to an endpoint that is to access the plurality of microservices.

Example 22 includes the apparatus of example 12, further including API processor circuitry to determine a service level agreement required response time and a warning threshold response time corresponding to the API specification.

Example 23 includes a non-transitory storage medium comprising instructions to cause programmable circuitry to at least generate a first test suite based on a plurality of combinations of a plurality of attributes corresponding to an API specification, test suite execution circuitry to transmit the first test suite to be executed on a query endpoint, the first test suite to include instructions to cause the query endpoint to access data stored in a database accessible to a plurality of secondary endpoints, obtain a response time corresponding to the access of the data, compare the response time corresponding to the access of the data with a service level agreement required response time, and in response to the response time corresponding to the access of the data being longer than the service level agreement required response time, notify a developer of the plurality of secondary endpoints.

The following claims are hereby incorporated into this Detailed Description by this reference. Although certain example systems, apparatus, articles of manufacture, and methods have been disclosed herein, the scope of coverage of this patent is not limited thereto. On the contrary, this patent covers all systems, apparatus, articles of manufacture, and methods fairly falling within the scope of the claims of this patent.

What is claimed is:

1. An apparatus to test an automated query language, the apparatus comprising:
network communication circuitry to interface with a query endpoint;
test suite generation circuitry to generate a first test suite based on a plurality of combinations of a plurality of attributes corresponding to an API specification;
test suite execution circuitry to transmit the first test suite to be executed on the query endpoint, the first test suite to include instructions to cause the query endpoint to access data stored in a database accessible to a plurality of secondary endpoints; and
analyzer circuitry to:
obtain a response time corresponding to the access of the data;
compare the response time corresponding to the access of the data with a service level agreement required response time; and
in response to the response time corresponding to the access of the data being longer than the service level agreement required response time, notify a developer of the plurality of secondary endpoints.

2. The apparatus of claim 1, wherein in response to the response time corresponding to the access of the data is longer than the service level agreement required response time, the analyzer circuitry is to cancel a deployment of the plurality of the secondary endpoints.

3. The apparatus of claim 1, wherein the analyzer circuitry is to compare the response time to a warning threshold time, the warning threshold time shorter than the service level agreement required response time.

4. The apparatus of claim 3, wherein the analyzer circuitry is to generate a report which lists the response time, the warning threshold time, and the service level agreement required response time.

5. The apparatus of claim 1, wherein the test suite execution circuitry is to transmit the test suite to the query endpoint in response to a notification corresponding to an update in one of the plurality of secondary endpoints.

6. The apparatus of claim 1, wherein the plurality of secondary endpoints correspond to a plurality of microservices.

7. The apparatus of claim 6, wherein the query endpoint corresponds to a stitching endpoint that stitches the plurality of microservices together into a unified application programming interface.

8. The apparatus of claim 1, wherein the test suite is composed of a plurality of test cases.

9. The apparatus of claim 8, wherein a first test case in the plurality of test cases is to test a first group of attributes of the plurality of secondary endpoints.

10. The apparatus of claim 1, wherein the test suite execution circuitry is to retrieve credentials from a vault, the credentials to access the query endpoint.

11. The apparatus of claim 1, wherein the test suite execution circuitry is further to retrieve the test suite from a test suite repository.

12. An apparatus to generate test suites, the apparatus comprising:
network interface circuitry to, in response to a notification that a first microservice of a plurality of microservices is updated, retrieve an application programming interface (API) specification of the plurality of microservices;
introspection circuitry to determine attributes that are present in the API specification;
combinatorial generation circuitry to generate a plurality of test cases based on the determined attributes; and
test suite packaging circuitry to package the plurality of test cases as a first test suite.

13. The apparatus of claim 12, wherein the introspection circuitry is to determine a number of queries and mutations present in the API specification.

14. The apparatus of claim 13, wherein the queries and the mutations correspond to different ones of the plurality of microservices.

15. The apparatus of claim 13, wherein the queries and the mutations correspond to different nodes of the API specification.

16. The apparatus of claim 13, wherein the introspection circuitry is further to determine an organization of the attributes that are present in the API specification.

17. The apparatus of claim 16, further including test data generation circuitry, the test data generation circuitry to generate sample data that follows the organization of the attributes.

18. The apparatus of claim 17, wherein the test data generation circuitry generates the test data by using random text generation, random unique user identifiers generation, random email address generation, and random number generation.

19. The apparatus of claim 18, wherein the test data is used with ones of the mutations to update data in a database in one of the plurality of microservices.

20. The apparatus of claim 12, wherein the combinatorial generation circuitry is to generate N factorial test cases, where N corresponds to a number of the determined attributes.

21. The apparatus of claim 12, further including endpoint processor circuitry to process an endpoint specification to determine a location corresponding to an endpoint that is to access the plurality of microservices.

22. The apparatus of claim 12, further including API processor circuitry to determine a service level agreement required response time and a warning threshold response time corresponding to the API specification.

23. A non-transitory storage medium comprising instructions to cause programmable circuitry to at least:
generate a first test suite based on a plurality of combinations of a plurality of attributes corresponding to an API specification;
test suite execution circuitry to transmit the first test suite to be executed on a query endpoint, the first test suite to include instructions to cause the query endpoint to access data stored in a database accessible to a plurality of secondary endpoints;
obtain a response time corresponding to the access of the data;
compare the response time corresponding to the access of the data with a service level agreement required response time; and
in response to the response time corresponding to the access of the data being longer than the service level agreement required response time, notify a developer of the plurality of secondary endpoints.
